(19) United States
(12) Patent Application Publication
(10) Pub. No.: US 2023/0296781 A1
(43) Pub. Date: Sep. 21, 2023

(54) METHOD AND CONTROLLER FOR CONTROLLING LASER SCANNING BY A ROTORCRAFT

(71) Applicant: Singapore University Of Technology And Design, Singapore (SG)

(72) Inventors: Shaohui FOONG, Singapore (SG); Chee How TAN, Singapore (SG); Danial Sufiyan Bin Shaiful -, Singapore (SG); Zheng Wei Emmanuel TANG, Singapore (SG)

(21) Appl. No.: 18/004,451

(22) PCT Filed: Jul. 7, 2021
(86) PCT No.: PCT/SG2021/050400

§ 371 Date: Jan. 6, 2023

(30) Foreign Application Priority Data
Jul. 7, 2020 (SG) 10202006547W

(51) Int. Cl. G01S 17/933; G01S 7/481; G01S 17/42; B64C 39/02

(52) U.S. Cl. CPC G01S 17/933; G01S 7/4817; G01S 17/42; B64C 39/024

(57) ABSTRACT

There is provided a method of controlling laser scanning by a rotorcraft. The rotorcraft includes: a rotatable body frame configured to rotate during flight; a laser rangefinder mounted on the rotatable body frame and configured to perform laser scanning; and a magnetometer configured to measure magnetic field. The method includes: obtaining magnetic field measurement data from the magnetometer while the rotatable body frame is rotating during flight, the magnetic field measurement data including a sinusoidal signal; estimating a frequency of the sinusoidal signal; and controlling the laser rangefinder to perform laser scanning based on the estimated frequency of the sinusoidal signal. There is also provided a corresponding controller for controlling laser scanning by a rotorcraft, and a corresponding rotorcraft configured to perform laser scanning including the controller.

### CROSS-REFERENCE TO RELATED APPLICATION

This is a national phase of PCT application PCT/SG2021/050400, which claims the benefit of priority of Singapore Patent Application No. 10202006547W, filed on 7 Jul. 2020, the contents of which are hereby incorporated by reference in their entirety for all purposes.

### TECHNICAL FIELD

The present disclosure generally relates to a method of controlling laser scanning by a rotorcraft, a controller thereof, and a rotorcraft configured to perform laser scanning including the controller.

### BACKGROUND

There exist various types of rotorcrafts, such as samara-inspired rotorcrafts (e.g., monocopters), in which the entire craft is configured to rotate (e.g., continuously rotates), generating lift for controlled flight. Early developmental work was led by Lockheed Martin Advanced Technology Laboratories, Massachusetts Institute of Technology (MIT), and the University of Maryland. Recent work by the Singapore University of Technology and Design focuses on the mechanical design, optimisation and control of new classes of transformable and unpowered swarm-capable samara-inspired rotorcrafts, such as those rotorcrafts referred to as the Transformable HOvering Rotorcraft (THOR) and Samara Autorotating Wing (SAW), respectively.

Furthermore, light detection and ranging (lidar) is a key technology used in autonomous navigation of aerial robots in diverse applications. Examples of lidar sensing applications include simple distance measurement using a unidirectional lidar for altimetry, collision avoidance using an array of unidirectional lidar for proximity detection, and advanced mapping using a 2D or 3D laser scanners to scan and create a digital pointcloud representation of the environment for simultaneous localisation and mapping (SLAM). For size, weight, and power (SWaP)-constrained aerial robots, lidar sensors have been used in innovative ways including “nodding” a 2D laser scanner to scan in 3D representation and optimising a sparse array of unidirectional lidar rangefinder to localise in environment with known geometrical a priori.

There has been keen interest towards platform miniaturization and achieving autonomy of rotorcrafts. For example, the size of the platform is affected by a multitude of factors, such as the rotation speed, wing span, payload, and so on. Significantly, the low dynamic range of commercially available gyroscopic sensors severely inhibit further miniaturisation effort. This is because smaller platform, thereby having a shorter wingspan and lesser aerodynamics surface, would entail a higher rotation speed to generate sufficient lift for agile flight. Furthermore, conventionally, the pursuit of autonomy requires additional sensors that would increase the payload requirement, which may increase the wingspan. Hence, conventionally, it has been challenging to achieve both miniaturisation and autonomy as the above-mentioned factors are conflicting. In particular, it has conventionally been challenging to achieve laser scanning (or lidar scanning) by a rotorcraft having a rotatable body frame configured to rotate during flight (e.g., the entire craft is configured to rotate), without significant or material drawbacks, such as significantly or materially increasing weight and/or complexity of the rotorcraft.

A need therefore exists to provide laser scanning (or lidar scanning) by a rotorcraft, that seek to overcome, or at least ameliorate, one or more deficiencies in conventional approaches in providing laser scanning by a rotorcraft, such as avoiding or minimizing significant or material drawbacks, for example, avoiding significant or material increase in weight and/or complexity of the rotorcraft. It is against this background that the present disclosure has been developed.

### SUMMARY

According to a first aspect of the present disclosure, there is provided a method of controlling laser scanning by a rotorcraft, the rotorcraft including a rotatable body frame configured to rotate during flight; a laser rangefinder mounted on the rotatable body frame and configured to perform laser scanning; and a magnetometer configured to measure magnetic field, the method including:
obtaining magnetic field measurement data from the magnetometer while the rotatable body frame is rotating during flight, the magnetic field measurement data including a sinusoidal signal;
estimating a frequency of the sinusoidal signal; and
controlling the laser rangefinder to perform laser scanning based on the estimated frequency of the sinusoidal signal.

According to a second aspect of the present disclosure, there is provided a controller for controlling laser scanning by a rotorcraft, the rotorcraft including a rotatable body frame configured to rotate during flight; a laser rangefinder mounted on the rotatable body frame and configured to perform laser scanning; and a magnetometer configured to measure magnetic field, the controller including:
a memory; and
at least one processor communicatively coupled to the memory and configured to:
   obtain magnetic field measurement data from the magnetometer while the rotatable body frame is rotating during flight, the magnetic field measurement data including a sinusoidal signal;
   estimate a frequency of the sinusoidal signal; and
   control the laser rangefinder to perform laser scanning based on the estimated frequency of the sinusoidal signal.

According to a third aspect of the present disclosure, there is provided a rotorcraft configured to perform laser scanning, the rotorcraft including:
a rotatable body frame configured to rotate during flight;
a laser rangefinder mounted on the rotatable body frame and configured to perform laser scanning;
a magnetometer configured to measure magnetic field; and
the controller for controlling the laser rangefinder to perform laser scanning as described according to the above-mentioned second aspect of the present disclosure.

According to a fourth aspect of the present disclosure, there is provided a computer program product, embodied in one or more non-transitory computer-readable storage mediums, including instructions executable by at least one processor to perform the method of controlling laser scanning by a rotorcraft as described according to the above-mentioned first aspect of the present disclosure.

### BRIEF DESCRIPTION OF THE DRAWINGS

Embodiments of the present disclosure will be better understood and readily apparent to one of ordinary skill in the art from the following written description, by way of example only, and in conjunction with the drawings, in which:

FIG. 1 depicts a schematic flow diagram of a method of controlling laser scanning by a rotorcraft, according to various embodiments of the present disclosure;

FIG. 2 depicts a schematic block diagram of a controller for controlling laser scanning by a rotorcraft, according to various embodiments of the present disclosure, such as corresponding to the method of controlling laser scanning by the rotorcraft as described with reference to FIG. 1;

FIG. 3 depicts a schematic drawing of a rotorcraft configured to perform laser scanning, according to various embodiments of the present disclosure;

FIG. 4A depicts a schematic drawing of an example type of rotorcraft configured to perform laser scanning, according to various embodiments of the present disclosure;

FIG. 4B shows a perspective view of the example rotorcraft of FIG. 4A performing laser scanning, according to various embodiments of the present disclosure;

FIG. 5 shows the axes of the earth-fixed frame E and the body-fixed frame B, according to various embodiments of the present disclosure;

FIG. 6 depicts an example implementation of the example rotorcraft (which may also be referred to herein as Flydar), according to various first embodiments of the present disclosure;

FIG. 7 depicts an example implementation of the Flydar mapping unit (FMU) of the example rotorcraft, according to various first example embodiments of the present disclosure;

FIG. 8 depicts an example experimental setup to simulate the physical rotation of a rotorcraft, according to various first example embodiments of the present disclosure;

FIG. 9 depicts a graph showing the estimated angular frequency \hat{ω}ₕ according to various first example embodiments of the present disclosure against the ground truth angular frequency ωₜᵣᵤₜₕ and the gyro measurement angular frequency ω_{gyro};

FIG. 10 depicts a graph showing the angular frequency \hat{ω}ₕ estimated on the rotorcraft during flight according to various first example embodiments of the present disclosure against the ground truth angular frequency ωₜᵣᵤₜₕ and the gyro measurement angular frequency ω_{gyro};

FIG. 11 depicts a one-second snapshot of the magnetometer measurement zₖ and the estimated (or predicted) extended Kalman filter (EKF) states x₂ and x₃;

FIG. 12 depicts a graph showing the estimated x and y position output from Google Cartographer SLAM in 2D generated from the example rotorcraft planar scan against the ground truth pose of the OptiTrack;

FIG. 13 depicts a graph showing the absolute x- and y- error of the position estimate from the SLAM in 2D generated from the example rotorcraft planar scan relating to FIG. 12;

FIG. 14 depicts a final map output generated from the example rotorcraft using Google Cartographer in 2D, according to various first example embodiments of the present disclosure;

FIG. 15 depicts a schematic block diagram of a phased-locked loop (PLL), according to various second example embodiments of the present disclosure;

FIG. 16 depicts the axes of the earth-fixed frame E and the body-fixed frame B, according to various embodiments of the present disclosure;

FIG. 17 depicts a graph of an example response of the PLL frequency estimate ω_{PLL} to a unit step frequency increase above \hat{ω}ₕ, according to various second example embodiments of the present disclosure;

FIG. 18 depicts a graph of the response of the PLL frequency estimate ω_{PLL} to a unit step frequency increase above \hat{ω}ₕ, according to various second example embodiments of the present disclosure;

FIG. 19 depicts a table (Table 1) showing various parameters used for the simulations conducted, according to various second example embodiments of the present disclosure;

FIG. 20 depicts a graph showing the convergence behavior of the PLL at 4 different proportional gains kₚ=1, 20, 45 and 75, according to various second example embodiments of the present disclosure;

FIG. 21 depicts an example experimental setup to simulate the physical rotation of a rotorcraft, according to various second example embodiments of the present disclosure;

FIG. 22 depicts a graph showing the PLL instantaneous frequency ω_{PLL} estimated from the PLL compared against the angular frequency ground truth measurement from the encoder ω_{encoder} and the angular frequency measurement from the on-board gyroscope ω_{gyro}, according to various second example embodiments of the present disclosure;

FIG. 23 depicts a graph showing the frequency output from the PLL ω_{PLL}, the encoder ω_{encoder} and the on-board gyroscope ω_{gyro}, when the rotating rig was spun above the gyroscope saturation limit ω_{gyro}^{limit}, according to various second example embodiments of the present disclosure;

FIG. 24 depicts a graph showing the absolute error of the PLL frequency estimate |ω_{PLL}−ω_{encoder}|, according to various second example embodiments of the present disclosure;

FIG. 25 depicts a graph showing the PLL frequency estimate ω_{PLL} compared against the angular frequency ground truth measurement from the OptiTrack ω_{optitrack} and the angular frequency measurement from the on-board gyroscope ω_{gyro}, according to various second example embodiments of the present disclosure;

FIG. 26 depicts a graph showing the PLL frequency estimate ω_{PLL} is compared against the angular frequency ground truth measurement from the OptiTrack ω_{optitrack} and the angular frequency measurement from the on-board gyroscope ω_{gyro}, when an example rotorcraft is hovering at an angular frequency above the gyroscope saturation limit ω_{gyro}^{limit}, according to various second example embodiments of the present disclosure; and

FIG. 27 depicts a graph showing the absolute error of the PLL frequency estimate |ω_{PLL}−ω_{optitrack}|, whereby the maximum error is 0.2406 Hz and the rms error is 0.0479 Hz, according to various second example embodiments of the present disclosure.

### DETAILED DESCRIPTION

Various embodiments of the present disclosure provide a method of controlling laser scanning by a rotorcraft, a controller thereof, and a rotorcraft configured to perform laser scanning including the controller.

There exist various types of rotorcrafts, such as samara-inspired rotorcrafts (e.g., monocopters), in which the entire craft is configured to rotate, generating lift for controlled flight. In addition, light detection and ranging (lidar) is a key technology used in a variety of sensing applications, such as but not limited to, scanning and mapping a surrounding environment to generate a digital pointcloud representation (pointcloud data) of the surrounding environment, for example, for simultaneous localisation and mapping (SLAM). However, as explained in the background, it has conventionally been challenging to achieve laser scanning (or lidar scanning) by a rotorcraft having a rotatable body frame configured to rotate during flight (e.g., the entire craft is configured to rotate), without significant or material drawbacks, such as significantly or materially increasing weight and/or complexity of the rotorcraft. Accordingly, various embodiments provide laser scanning (or lidar scanning) by a rotorcraft, that seek to overcome, or at least ameliorate, one or more deficiencies in conventional approaches in providing laser scanning by a rotorcraft, such as avoiding or minimizing significant or material drawbacks, for example, avoiding significant or material increase in weight and/or complexity of the rotorcraft.

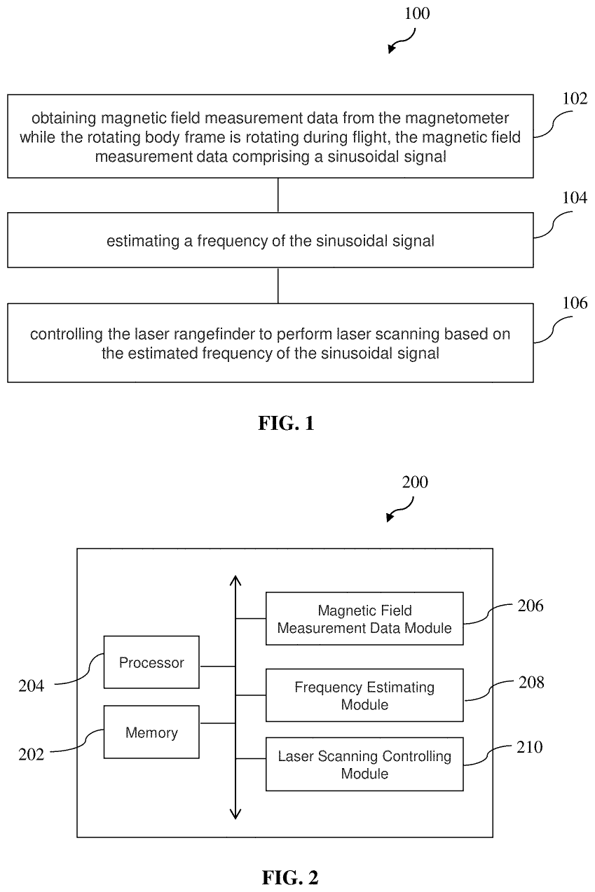

FIG. 1 depicts a schematic flow diagram of a method 100 of controlling laser scanning by a rotorcraft, according to various embodiments of the present disclosure. The rotorcraft including a rotatable body frame configured to rotate during flight; a laser rangefinder mounted on the rotatable body frame and configured to perform laser scanning; and a magnetometer configured to measure magnetic field. The method 100 of controlling laser scanning by the rotorcraft includes: obtaining (at 102) magnetic field measurement data from the magnetometer while the rotatable body frame is rotating during flight, the magnetic field measurement data including a sinusoidal signal; estimating (at 104) a frequency of the sinusoidal signal; and controlling (at 106) the laser rangefinder to perform laser scanning based on the estimated frequency of the sinusoidal signal.

In various embodiments, the laser scanning by the rotorcraft is performed by the laser rangefinder mounted on the rotatable body frame of the rotorcraft. The laser scanning (or lidar scanning) may be performed with respect to a surrounding environment to produce a digital pointcloud representation (pointcloud data) of the surrounding environment, such as for localization and/or mapping applications. The working principles and operations of a laser rangefinder in performing laser scanning (or lidar scanning) is well known in the art and thus need not be described herein for clarity and conciseness. It will be understood by a person skilled in the art that the present disclosure is not limited to any particular type of laser scanning for any particular application, as long as the laser scanning is performed with respect to a surrounding environment to produce a digital pointcloud representation (pointcloud data) of the surrounding environment, and in particular, a planar lidar scan using a single unidirectional laser.

In various embodiments, the above-mentioned controlling laser scanning by the rotorcraft or controlling the laser rangefinder to perform laser scanning is in relation to controlling the pointcloud data produced by the laser rangefinder based on the estimated frequency of the sinusoidal signal, and in particular, for enabling the laser rangefinder to produce planar pointcloud data for a complete planar lidar scan corresponding to one complete or full revolution (i.e., 360 degrees or substantially thereof). Accordingly, the method 100 enables the laser rangefinder to produce a plurality of planar pointcloud data corresponding to a plurality of complete planer lidar scans, respectively, during flight of the rotorcraft. In various embodiments, based on the estimated frequency of the sinusoidal signal, the laser rangefinder may also be controlled to produce planar pointcloud data for a partial planar lidar scan corresponding to a partial revolution over a predetermined or predefined range of angles. In various embodiments, a plurality of planar (i.e., two-dimensional (2D)) pointcloud data may be combined to form three-dimensional (3D) pointcloud data associated with a surrounding environment.

In various embodiments, the rotatable body frame may be configured to rotate about a rotational axis thereof during flight, which corresponds to (or is the same as) a rotational axis of the rotorcraft. In various embodiments, as the laser rangefinder is mounted on the rotatable body frame, the laser rangefinder is advantageously actuated (rotated) together with the rotatable body frame for performing laser scanning by virtue of the rotatable body frame rotating during flight. In various embodiments, the rotorcraft may refer to any type of rotorcraft as long as the rotorcraft has a rotatable body frame (main body frame) configured to rotate during flight, such as the entire craft rotating during flight.

Accordingly, the method 100 of controlling laser scanning according to various embodiments of the present disclosure advantageously controls laser scanning based on the estimated frequency of the sinusoidal signal (sinusoidal waveform) of the magnetic field measurement data generated from the magnetometer while the rotatable body frame is rotating during flight. In this regard, such magnetic field measurement data is already available (or already generated) from the rotorcraft, and more specifically, from a magnetometer in an existing inertial measurement unit (IMU) of the rotorcraft. Therefore, the method 100 of controlling laser scanning according to various embodiments of the present disclosure advantageously make use of sensor data, and more specifically, magnetic field measurement data, that is already available (or already generated) from the rotorcraft, and thus, advantageously avoids or minimizes significant or material drawbacks associated with conventional approaches, for example, avoids significant or material increase in weight and/or complexity of the rotorcraft since, for example, no additional sensor(s) is required to be mounted on the rotorcraft. These advantages or technical effects, and/or other advantages or technical effects, will become more apparent to a person skilled in the art as the method 100 of controlling laser scanning, as well as the corresponding controller for controlling laser scanning, is described in more detail according to various embodiments and example embodiments of the present disclosure.

In various first embodiments, the frequency of the sinusoidal signal is estimated based on an extended Kalman filter.

In various first embodiments, the rotorcraft further includes a gyroscope mounted on the rotatable body frame and configured to measure an angular velocity thereof about a rotational axis of the rotatable body frame. In this regard, the above-mentioned estimating (at 104) the frequency of the sinusoidal signal includes: obtaining gyroscope measurement data from the gyroscope, the gyroscope measurement data including measured angular velocity data measured by the gyroscope about the rotational axis of the rotatable body frame; and computing the frequency of the sinusoidal signal based on the measured angular velocity data as a control input to the extended Kalman filter. That is, the measured angular velocity data is provided or supplied as a control input to the extended Kalman filter.

In various first embodiments, the above-mentioned estimating (at 104) the frequency of the sinusoidal signal further includes estimating a gyro bias associated with the gyroscope in relation to the measured angular velocity data based on an estimated state in the extended Kalman filter. In this regard, the above-mentioned computing the frequency of the sinusoidal signal is further based on the estimated gyro bias.

In various first embodiments, the above-mentioned the extended Kalman filter is based on a state transition function, the measured angular velocity data is a control input to the state transition function, and the estimated gyro bias is an estimated state in the state transition function.

In various first embodiments, the above-mentioned computing the frequency of the sinusoidal signal is further based on a difference between the measured angular velocity data and the estimated gyro bias.

In various second embodiments, the frequency of the sinusoidal signal is estimated based on a phase-locked loop.

In various second embodiments, the phase-locked loop includes a phase detector, a loop filter and a numerically-controlled oscillator, the phase detector being configured to compare a phase of an output signal of the phase-locked loop with a phase of a reference input signal of the phase-locked loop to produce an error signal. In this regard, the reference input signal is based on the sinusoidal signal of the magnetic field measurement data.

In various second embodiments, each of the reference input signal and the output reference signal is a complex sinusoidal signal.

In various second embodiments, the complex sinusoidal signal of the reference input signal is produced (or constructed) based on a first component and a second component of the sinusoidal signal. In various embodiments, the first component corresponds to a front direction of the rotorcraft and the second component corresponds to a starboard direction of the rotorcraft.

In various second embodiments, the frequency of the sinusoidal signal is estimated based on an instantaneous frequency of the numerically-controlled oscillator. In other words, the estimated frequency of the sinusoidal signal corresponds to the instantaneous frequency of the numerically-controlled oscillator.

In various second embodiments, similar to various first embodiments, the rotorcraft further includes a gyroscope mounted on the rotatable body frame and configured to measure an angular velocity thereof about a rotational axis of the rotatable body frame. In this regard, the above-mentioned estimating (at 104) the frequency of the sinusoidal signal includes: obtaining gyroscope measurement data from the gyroscope, the gyroscope measurement data including measured angular velocity data measured by the gyroscope about the rotational axis of the rotatable body frame; and setting a free-running frequency of the numerically-controlled oscillator based on the measured angular velocity data.

In various embodiments (i.e., including various first and second embodiments), the above-mentioned controlling (at 106) the laser rangefinder includes: determining an angular velocity of the rotorcraft based on the estimated frequency of the sinusoidal signal; and sending the determined angular velocity of the rotorcraft to the laser rangefinder, the laser rangefinder being configured to perform laser scanning based on the determined angular velocity of the rotorcraft.

In various embodiments, the laser rangefinder is a single unidirectional laser and is configured to generate planar pointcloud data for a complete planar lidar scan based on the determined angular velocity of the rotorcraft. In this regard, the complete planar lidar scan is a planar lidar scan having completed a full revolution as determined based on the determined angular velocity of the rotorcraft. In other words, the determined angular velocity of the rotorcraft is used to determine that a planar lidar scan has completed one full revolution, and thus a planar pointcloud data corresponding to one complete planar lidar scan can be produced. A plurality of planar pointcloud data corresponding to a plurality of complete planer lidar scans, respectively, may each also be produced in the same or similar manner.

In various embodiments, the rotorcraft is configured to entirely rotate (e.g., about a rotational axis thereof) during flight.

FIG. 2 depicts a schematic block diagram of a controller 200 for controlling laser scanning by a rotorcraft, according to various embodiments of the present disclosure, such as corresponding to the above-mentioned method 100 of controlling laser scanning by the above-mentioned rotorcraft as described hereinbefore according to various embodiments of the present disclosure with reference to FIG. 1. Accordingly, similarly, the rotorcraft includes a rotatable body frame configured to rotate during flight; a laser rangefinder mounted on the rotatable body frame and configured to perform laser scanning; and a magnetometer configured to measure magnetic field. The controller 200 includes: a memory 202; and at least one processor communicatively coupled to the memory 202 and configured to: obtain magnetic field measurement data from the magnetometer while the rotatable body frame is rotating during flight, the magnetic field measurement data including a sinusoidal signal; estimate a frequency of the sinusoidal signal; and control the laser rangefinder to perform laser scanning based on the estimated frequency of the sinusoidal signal.

It will be appreciated by a person skilled in the art that the at least one processor 204 may be configured to perform various functions or operations through set(s) of instructions (e.g., software modules) executable by the at least one processor 204 to perform various functions or operations. Accordingly, as shown in FIG. 2, the controller 200 may include: a magnetic field measurement data module (or a magnetic field measurement data circuit) 206 configured to obtain magnetic field measurement data from the magnetometer while the rotatable body frame is rotating during flight, the magnetic field measurement data including a sinusoidal signal; a frequency estimating module (or a frequency estimating circuit) 208 configured to estimate a frequency of the sinusoidal signal; and a laser scanning controlling module (or a laser scanning controlling circuit) 210 configured to control the laser rangefinder to perform laser scanning based on the estimated frequency of the sinusoidal signal.

It will be appreciated by a person skilled in the art that the above-mentioned modules are not necessarily separate modules, and two or more modules may be realized by or implemented as one functional module (e.g., a circuit or a software program) as desired or as appropriate without deviating from the scope of the present disclosure. For example, two or more of the magnetic field measurement data module 206, the frequency estimating module 208 and the laser scanning controlling module 210 may be realized (e.g., compiled together) as one executable software program (e.g., software application or simply referred to as an “app”), which for example may be stored in the memory 202 and executable by the at least one processor 204 to perform the corresponding functions or operations as described herein according to various embodiments.

In various embodiments, the controller 200 for controlling laser scanning corresponds to the method 100 of controlling laser scanning as described hereinbefore with reference to FIG. 1, therefore, various functions or operations configured to be performed by the least one processor 204 may correspond to various steps of the method 100 described hereinbefore according to various embodiments, and thus need not be repeated with respect to the controller 200 for clarity and conciseness. In other words, various embodiments described herein in context of methods (e.g., the method 100 of controlling laser scanning) are analogously valid for the corresponding systems or devices (e.g., the controller 200 for controlling laser scanning), and vice versa. For example, in various embodiments, the memory 202 may have stored therein the magnetic field measurement data module 206, the frequency estimating module 208 and/or the laser scanning controlling module 210, each corresponding to one or more steps of the method 100 of controlling laser scanning as described hereinbefore according to various embodiments, which are executable by the at least one processor 204 to perform the corresponding functions or operations as described herein.

A computing system, a controller, a microcontroller or any other system providing a processing capability may be provided according to various embodiments in the present disclosure. Such a system may be taken to include one or more processors and one or more computer-readable storage mediums. For example, the controller 200 described hereinbefore may include a processor (or controller) 204 and a computer-readable storage medium (or memory) 202 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of various functions or operations may also be understood as a “circuit” in accordance with various other embodiments. Similarly, a “module” may be a portion of a system according to various embodiments in the present disclosure and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “estimating”, “controlling”, “computing”, “setting”, “determining”, “sending”, “performing” or the like, refer to the actions and processes of a computer system or electronic device, that manipulates and transforms data represented as physical quantities within the computer system into other data similarly represented as physical quantities within the computer system or other information storage, transmission or display devices.

The present specification also discloses a system (e.g., which may also be embodied as a device or an apparatus), such as the controller 200, for performing various operations or functions of the method(s) described herein. Such a system may be specially constructed for the required purposes, or may include a general purpose computer or other device selectively activated or reconfigured by a computer program stored in the computer. Algorithms that may be presented herein are not inherently related to any particular computer or other apparatus. Various general-purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that individual steps of various methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the present disclosure. It will be appreciated by a person skilled in the art that various modules described herein (e.g., the magnetic field measurement data module 206, the frequency estimating module 208 and/or the laser scanning controlling module 210) may be software module(s) realized by computer program(s) or set(s) of instructions executable by a computer processor to perform various functions or operations, or may be hardware module(s) being functional hardware unit(s) designed to perform various functions or operations. It will also be appreciated that a combination of hardware and software modules may be implemented.

Furthermore, one or more of the steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements various steps of methods described herein.

In various embodiments, there is provided a computer program product, embodied in one or more computer-readable storage mediums (non-transitory computer-readable storage medium), including instructions (the magnetic field measurement data module 206, the frequency estimating module 208 and/or the laser scanning controlling module 210) executable by one or more computer processors to perform a method 100 of controlling laser scanning by a rotorcraft, as described hereinbefore with reference to FIG. 1. Accordingly, various computer programs or modules described herein may be stored in a computer program product receivable by a system therein, such as the controller 200 as shown in FIG. 2, for execution by at least one processor 204 of the system 200 to perform various functions or operations.

Various software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

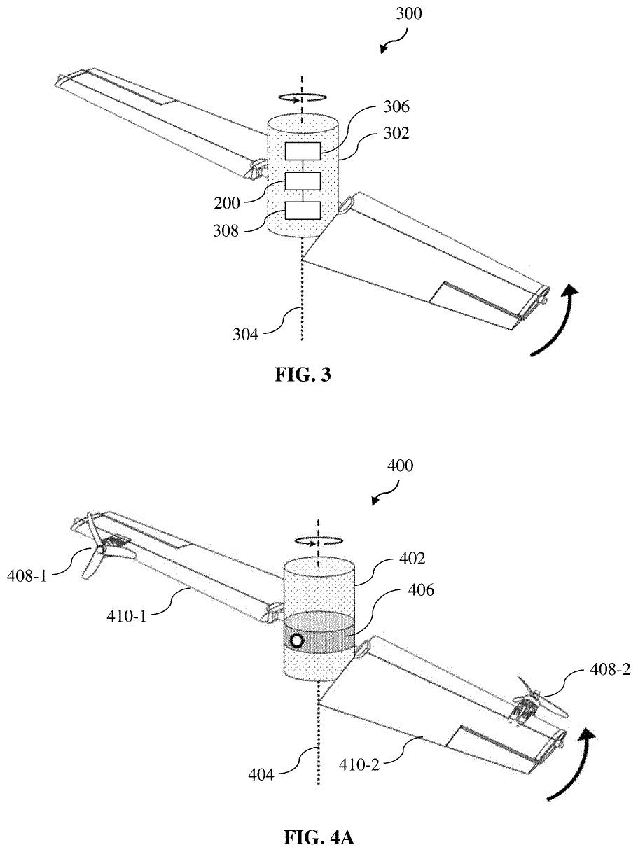

FIG. 3 depicts a schematic drawing of a rotorcraft 300 configured to perform laser scanning, according to various embodiments. The rotorcraft 300 includes: a rotatable body frame 302 configured to rotate (e.g., about a rotational axis 304) during flight; a laser rangefinder 306 mounted on the rotatable body frame 302 and configured to perform laser scanning; a magnetometer 308 configured to measure magnetic field; and the controller 200 for controlling the laser rangefinder 306 to perform laser scanning as described hereinbefore with reference to FIG. 2 according to various embodiments.

It will be understood by a person skilled in the art that various types of rotorcraft are known in the art and the present disclosure is not limited to any particular type of rotorcraft as long as the rotorcraft includes a rotatable body frame (main body frame) configured to rotate during flight, such as a rotorcraft configured to entirely rotate during flight. Various configurations and operating mechanisms or principles of such a rotorcraft are known in the art and thus need not be described herein for clarity and conciseness, and the present disclosure is not limited to any particular configuration or operating mechanism of a rotorcraft.

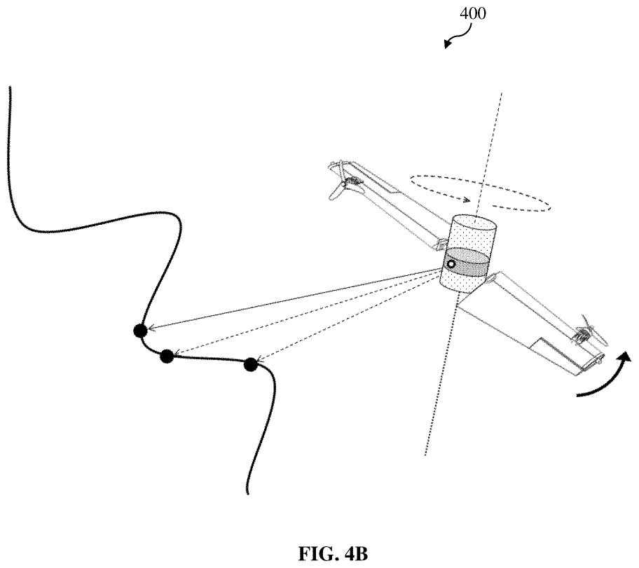

By way of an example only and without limitation, FIG. 4A depicts a schematic drawing of an example type of rotorcraft 400 configured to perform laser scanning according to various embodiments of the present disclosure. As shown in FIG. 4A, the rotorcraft 400 is configured to rotate during flight based on two thruster units 408-1, 408-2, each thruster unit being mounted on an edge of a respective wing member 410-1, 410-2. The rotorcraft 400 includes a rotatable body frame 402 configured to rotate (e.g., about a rotational axis 404) during flight; a laser rangefinder 406 mounted on the rotatable body frame 402 and configured to perform laser scanning. For simplicity and clarity, the magnetometer configured to measure magnetic field and the controller for controlling the laser rangefinder 406 to perform laser scanning are not shown in FIG. 4A. For illustration purpose, FIG. 4B shows a perspective view of the rotorcraft 400 performing laser scanning, according to various embodiments of the present disclosure.

It will be appreciated by a person skilled in the art that the terminology used herein is for the purpose of describing various embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Any reference to an element or a feature herein using a designation such as “first”, “second” and so forth does not limit the quantity or order of such elements or features, unless stated or the context requires otherwise. For example, such designations may be used herein as a convenient way of distinguishing between two or more elements or instances of an element. Thus, a reference to first and second elements does not necessarily mean that only two elements can be employed, or that the first element must precede the second element. In addition, a phrase referring to “at least one of” a list of items refers to any single item therein or any combination of two or more items therein.

In order that the present disclosure may be readily understood and put into practical effect, various example embodiments of the present disclosure will be described hereinafter by way of examples only and not limitations. It will be appreciated by a person skilled in the art that the present disclosure may, however, be embodied in various different forms or configurations and should not be construed as limited to the example embodiments set forth hereinafter. Rather, these example embodiments are provided so that this disclosure will be thorough and complete, and will fully convey the scope of the present disclosure to those skilled in the art.

In particular, for better understanding of the present disclosure and without limitation or loss of generality, various example embodiments of the present disclosure will now be described with respect to the example rotorcraft 400 (which may also be referred to as an aerial robot herein) as shown in FIGS. 4A and 4B for simultaneous localization and mapping (which may be referred to herein as SLAM). However, as explained hereinbefore, it will be understood by a person skilled in the art that various types of rotorcraft are known in the art and the present disclosure is not limited to any particular type of rotorcraft as long as the rotorcraft includes a rotatable body frame configured to rotate during flight, such as a rotorcraft configured to entirely rotate during flight, and is not limited to any particular type of laser scanning application.

Various example embodiments provide a rotorcraft configured to perform laser scanning (e.g., such as rotorcraft may be referred to herein as Flydar) with magnetometer-based high angular rate estimation (i.e., estimation of angular rate (which may also interchangeably be referred to herein as angular velocity) that is relatively high, such as higher than the angular rate capable of being measured by a gyroscope (gyroscope saturation limit) mounted on the rotorcraft) for SLAM. Advantageously, according to various example embodiments, sensor data that is already available (already generated) on the inertial measurement unit (IMU) of the rotorcraft (e.g., monocopter) is used for high angular rate sensing. In particular, as will be explained later below in detail, various example embodiments found that the sinusoidal nature of the magnetometer data generated from the rotating dynamics of the airframe (rotatable body frame) may be used for angular rate estimation. More specifically, various example embodiments found that the frequency (in particular, fundamental frequency) of the sinusoidal signal of the magnetometer data corresponds to the angular rate (or rotation rate) of the rotorcraft.

For example, existing methods using MARG (Magnetic, Angular, and Gravity) sensor data use accelerometer data to provide a vertical gravity reference. However, this is not suitable for all-rotating unmanned aerial vehicle (UAV) that experiences significant centripetal acceleration due to the rotating dynamics. There exist conventional approaches for determining the UAV's angular rates. For example, in Lembono et al., “Orientation filter and angular rates estimation in monocopter using accelerometers and magnetometer with the Extended Kalman Filter,” 2017 IEEE International Conference on Robotics and Automation (ICRA), 2017, pages 4537-4543 (herein referred to as the Lembono reference), the authors proposed using an array of accelerometer to estimate the angular rate of a monocopter from its centripetal acceleration. The accelerometer array was successfully demonstrated up to 9 Hz on monocopter flight. In Fries et al., “Design and implementation of a compact rotational speed and air flow sensor for unmanned aerial vehicles,” IEEE Sensors Journal, vol. 19, no. 22, pages 10298-10307, November 2019 (herein referred to as the Fries reference), the authors proposed combining a barometric sensor and a steel ball sensing element into a compact rotation speed sensor (RSS). The centrifugal force, due to the rotating dynamics, acting on the steel ball translates into a change in the measured pressure of the integrated barometer. The RSS was demonstrated in monocopter flight to operate reliably up to a rotation speed of 10 Hz. While these effort managed to outperform the typical gyroscope, the additional sensors required, such as accelerometer and barometer sensors, add weight and complexity to the platform.

An omnidirectional 2D planar lidar or a 3D lidar may be used to provide autonomy on conventional aerial robots, such as a quadcopter. For example, the pointcloud generated may be fed into a SLAM pipeline for autonomous navigation. In various example embodiments, leveraging on the rotating dynamics of a rotorcraft (e.g., a samara-inspired rotorcraft), a single-point laser is advantageously dynamically actuated (rotated) for planar scanning. In particular, various example embodiments provide an integrated rotorcraft and lidar platform (which may be referred to herein as the Flying Lidar or Flydar). In this regard, while conventional 2D lidar has rotating mechanism with fixed known rate to generate stable scans, the time-varying and unknown rotation rate of rotorcraft poses a key challenge in performing lidar scanning by a rotorcraft installed with the conventional 2D lidar device.

There are existing literature in the field of power system relating to the frequency estimation of single-tone noisy real sinusoid. For example, in Routray et al., “A novel kalman filter for frequency estimation of distorted signals in power systems,” IEEE Transactions on Instrumentation and Measurement, vol. 51, no. 3, pages 469-479, June 2002 (herein referred to as the Routray reference), an extended Kalman filter (EKF)-based algorithm was proposed for an online recursive frequency estimation of a noisy sinusoidal signal. The algorithm was demonstrated to track abrupt frequency changes of simulated signal effectively. The EKF-based approach is less computationally demanding compared to Fourier transform-based and neural network-based algorithm proposed in literature. In this regard, various first example embodiments (e.g., corresponding to various first embodiments as described hereinbefore) provide an EKF-based angular rate estimation that extends on the technique or approach disclosed in the Routray reference by incorporating gyroscope sensor measurement as a control input to better track transient changes and not just limited to abrupt frequency changes. Furthermore, various first example embodiments incorporate the gyro bias as an estimated state in the EKF to enable estimation of the high angular rate even under gyro saturation.

### Angular Rate Estimation Method based on Magnetometer and Gyroscope Sensor Data

In various first example embodiments, an angular rate estimation method (e.g., angular rate estimation algorithm) that uses the magnetometer and gyroscope sensor data from existing IMU measurement is provided. In addition, in various first example embodiments, a lightweight single laser unit for SLAM is provided. In this regard, the laser advantageously leverages on the rotating locomotion of the rotorcraft to generate a planar lidar scan for lightweight autonomy.

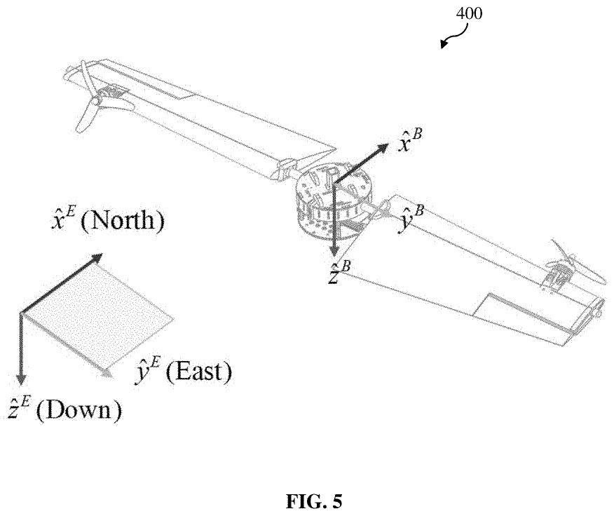

In various example embodiments (including various first example embodiments described herein and various second example embodiments to be described later below), the North-East-Down (NED) convention is adopted for all reference frame. The basis of the earth-fixed frame E, \hat{x}^{E}, ŷ^{E}, and \hat{z}^{E} axes are oriented along the north, east and down direction respectively. The body-fixed frame B is assumed to be on the robot's centre of mass, with the \hat{x}^{B}, ŷ^{B}, and \hat{z}^{B} axes pointing towards the front, starboard, and downward direction respectively. For illustration purpose, FIG. 5 shows the axes of the earth-fixed frame E and the body-fixed frame B.

### Magnetometer Sensor Model

A magnetometer measures the earth's magnetic field m^{E} experienced in the rotorcraft body frame B. An accent (\hat{ }) herein denotes that the vector has a unit norm, for example, \hat{m}=1 and \hat{m}=m/∥m∥. The normalised earth frame magnetic field m^{E} is defined as:

\hat{m}^{E}=[m_{N} 0 m_{D}]^{T} Equation (1)

The normalised body frame measurement \hat{m}^{B} can be modelled by a simple rotation of \hat{m}^{E} using the rotation matrix R_{E}^{B}. Then, \hat{m}^{B} is defined as:

\hat{m}^{B}=[mₓ m_{y} m_{z}]^{T}=R_{E}^{B}\hat{m}^{E} Equation (2)

where R_{E}^{B} describes the rotation from earth frame E to body frame B in ZYX order and θ, φ, ψ represents the yaw angle, pitch angle, and roll angle, respectively.

$${R}_{E}^{B} = [ \begin{matrix}c θ c ϕ & c θ s ϕ & - s θ \\ - c ψ s ϕ + s ψ s θ c ϕ & c ψ c ϕ + s ψ s θ s ϕ & s ψ c θ \\ s ψ s ϕ + c ψ s θ c ϕ & - s ψ c ϕ + c ψ s θ s ϕ & c ψ c θ\end{matrix} ] \qquad Equation ( 3 )$$

The robot angular velocity is given as:

ω^{B}=[ωₓ ω_{y} ω_{z}]^{T} Equation (4)

In hover flight, where ωₓ=ω_{y}=0, the robot rotation axis \hat{ω}^{B} can be assumed to be aligned with the earth frame vertical axis z^{E}. Then, the robot hovering angular velocity ωₕ^{B} is given as:

ωₕ^{B}=[0 0 ωₕ]^{T}=ωₕ\hat{z}^{B}=ωₕ\hat{z}^{E} Equation (5)

Finally, using Equations (1) to (5), the discrete-time model of the magnetometer measurement during hover flight is derived. The k^{th} normalised sample \hat{m}ₖ^{B} is defined as:

$${\hat{m}}_{k}^{B} = [ \begin{matrix}{m}_{N} cos ( {ω}_{h} {kT}_{s} + {ϕ}_{m} ) \\ {m}_{N} sin ( {ω}_{h} {kT}_{s} + {ϕ}_{m} ) \\ {m}_{D}\end{matrix} ] + {ϵ}_{k} \qquad Equation ( 6 )$$

where the mₓ and m_{y} measures a sinusoid with angular frequency ωₕ, initial phase shift ϕₘ, and Tₛ denotes the sampling time, and ϵₖ describes the measurement noise.

### Gyroscopic Sensor

A 3-axis gyroscope mounted on the robot measures the angular velocity ω_{gyro}^{B} about the body frame B. The dynamic range of the sensor is denoted as ω_{gyro,limit}. Then, the gyro output magnitude can be modelled as shown in Equation (7) below:

$$‖ {ω}_{gyro , i}^{B} ‖ = \{ \begin{matrix}‖ {ω}_{i}^{B} ‖ & if ‖ {ω}_{i}^{B} ‖ \leq {ω}_{gyro , limit} , \\ {ω}_{gyro , limit} & if ‖ {ω}_{i}^{B} ‖ \geq {ω}_{gyro , limit}\end{matrix} . \qquad Equation ( 7 )$$

where the subscript i denotes the x, y, or z axis.

The gyro model often incorporates an additive term ω_{bias} to account for the effects of gyro drifts due to thermal fluctuation. In contrast, various first example embodiments utilize the gyro bias ω_{bias} to capture the difference between the true hovering angular velocity ωₕ and the saturated gyro output ω_{gyro}^{B}, such that:

ω_{bias,k}=ω_{h,k}−ω_{gyro,k} Equation (8)

Finally, the discrete-time gyro model is given as:

ω_{gyro,z,k}=ω_{h,k}−ω_{bias,k}+ϵₖ Equation (9)

### EKF-Based Angular Rate Estimation

As derived in Equation (6), the magnetometer measures a sinusoidal signal due to the robot rotating dynamics for aerial flight. As described in the above-mentioned Routray reference, the angular frequency of the sinusoidal signal can be estimated using an EKF. Formally, a nonlinear process can be modelled as:

xₖ₊₁=f(xₖ, uₖ)+ωₖ Equation (10)

zₖ=g(xₖ, uₖ)+vₖ Equation (11)

where Equation (10) describes the state transition process, and the measurement equation as Equation (11).

The magnetometer model derived in Equation (6) can be re-written using linear prediction. For a real sinusoid with fundamental angular frequency ω_{f}, a closed-form equation based on the past two samples can be used to predict the future sample yₖ₊₁:

yₖ₊₁=2·cos(ω_{f}Tₛ)·yₖ−yₖ₋₁. Equation (12)

Compared to the EKF presented in the above-mentioned Routray reference, the EKF according to various first example embodiments incorporates the gyroscope measurements, modelled as a control input. This improves the transient tracking performance of the filter during take off and descent. Additionally, the gyroscope bias ω_{bias} is also modelled in the filter, to account for the saturated gyroscope measurement described in Equation (7) when ∥ωᵢ^{B}∥>ω_{gyro,limit}. Then, Equation (12) becomes:

yₖ₊₁=2·cos((ω_{gyro}+ω_{gyro})Tₛ)·yₖ−yₖ₋₁ Equation (13)

In the following, the EKF formulation is outlined. Firstly, let the state vector xₖ and the control input uₖ be:

xₖ=[ω_{bias,k} yₖ yₖ₋₁]^{T} Equation (14)

uₖ=ω_{gyro} Equation (15)

Secondly, the state transition function can then defined as

$$\begin{matrix}{\hat{x}}_{k + 1} = f ( {\hat{x}}_{k} , {u}_{k} ) \\ = [ \begin{matrix}{x}_{k , 1} \\ 2 \cdot cos ( ( {u}_{k} + {x}_{k , 1} ) {T}_{s} ) \cdot {x}_{k , 2} - {x}_{k , 3} \\ {x}_{k , 2}\end{matrix} ]\end{matrix} \qquad Equation ( 16 )$$

where uₖ is the control input defined in Equation (15), xₖ is the state vector defined in Equation (14), and x_{k,i} refers to the i^{th} element in xₖ.

Thirdly, the measurement function is identified as:

zₖ=g(\hat{x}ₖ, uₖ)=x_{k,2} Equation (17)

where zₖ is the x-axis measurement from the magnetometer.

Lastly, the hovering angular velocity of the robot can be estimated as:

\hat{ω}ₕ=uₖ−\hat{x}_{k,1} Equation (18)

where \hat{x}_{k,1}=\hat{ω}_{bias} is the estimated gyro bias.

### Polar Extrapolation for Uniform Sampling

Significantly, the linear prediction model given in Equation (12) used to derive the state transition function Equation (16) assumes a constant sampling period Tₛ. Hence, it is desired that the EKF measurement update step is executed at a fixed frequency with period Tₛ. Then, zₖ is extrapolated from the latest sample using the following:

$${z}_{k} = {z}_{k - 1} \cdot \frac{cos ( {θ}_{k - 1} + {\hat{ω}}_{h , k - 1} ( {t}_{k} - {t}_{k - 1} ) )}{cos {θ}_{k - 1}} \qquad Equation ( 19 )$$

where zₖ₋₁ and θₖ₋₁ are the last magnetometer measurements and phase angle respectively, \hat{ω}_{h,k-1} is the previous angular velocity estimated, tₖ is the EKF time now and tₖ₋₁ is time of arrival of zₖ_{₁} sample.

### Planar Pointcloud for SLAM

A single laser mounted on the robot generates n planar scans per second due to the rotating dynamics of the robot. Assuming a laser with sampling rate of N per seconds, and the robot with an instantaneous angular velocity ωₕ, the output rate of the f_{lidar} is simply

$$\frac{ω}{2 π} ,$$

and the average size of each scan m and the angular resolution Δθ is defined as:

$$m = \frac{N \cdot 2 π}{{ω}_{h}} \qquad Equation ( 20 )$$

$$Δ θ = \frac{2 π}{m} \qquad Equation ( 21 )$$

Let p_{θ} be the range measurements from the laser received at yaw angle θ. The measurements are accumulated in a pointcloudp and is output when the robot completes a full revolution. For convenience, the magnetic north, that is, θ=0, is selected as reference. At θ=0, which is the zero-crossing of the robot's yaw, a complete scan P is produced. The average angular rate ω̅ₕ is used to distribute the points evenly across the pointcloud.

During hover flight, the angular resolution across is approximately constant. However, during climb or descent, the angular velocity of the robot varies significantly. As a result, consecutive scans will have different angular resolution.

For illustration purpose, an example hardware implementation of the Flydar Mapping Unit is first presented. This is followed by the experimental investigations to evaluate the performance of the angular rate estimation method according to various first example embodiments and the mapping approach.

### Hardware Implementation

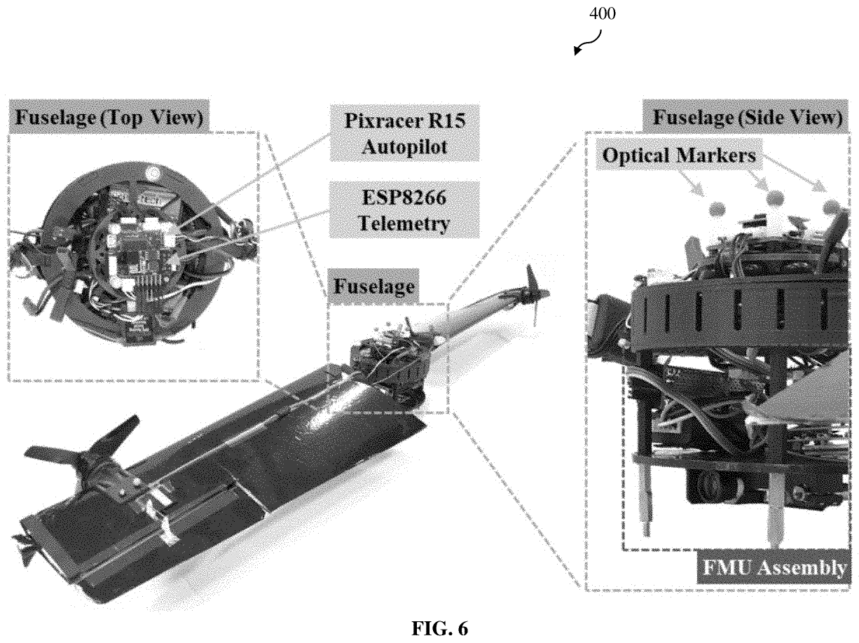

For illustration purpose and without limitation, FIG. 6 depicts an example implementation of the example rotorcraft 400 according to various first example embodiments of the present disclosure, with a number of key components shown. The rotorcraft 400 may include a DJI Snail 2305 powertrain, a Pixracer R15 autopilot with built-in IMU, and an example Flydar Mapping Unit (FMU) according to various first example embodiments of the present disclosure. For example, the FMU may be mounted onto the fuselage of the rotorcraft 400. In addition, optical markers may be mounted on the rotorcraft 400 for ground truth measurements (e.g., tracking the ground truth pose) using motion capture system. In the example implementation, the rotorcraft 400 weighs 500 g and has a wingspan of 1 m.

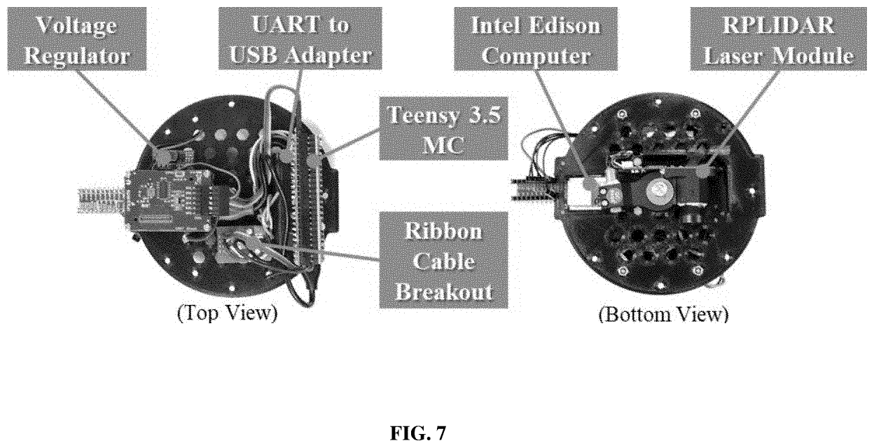

For illustration purpose and without limitation, FIG. 7 depicts an example implementation of the FMU of the example rotorcraft 400, according to various first example embodiments of the present disclosure, with a number of key components shown. The FMU may include two mounting plates. A first mounting plate may have mounted thereon a Pixhawk 2.1 autopilot and a 3000 mAh Lithium Polymer (LiPo) battery that powers the entire FMU, as can be seen from the top view shown in FIG. 7. A second mounting plate may have mounted thereon a RPLIDAR-A3 single-point laser module, with a sampling rate of up to 16,000 samples/second, at the bottom thereof. The laser module may receive and output data via a ribbon cable, which may be accessed through the ribbon cable breakout board. For example, an Intel Edison Companion Computer (IECC) may be configured to perform the angular rate estimation method (e.g., execute the angular rate estimation algorithm) according to various first example embodiments of the present disclosure and output the estimated angular frequency to a Teensy 3.5 MC (TMC) via a serial connection. The TMC may then relay the angular rate (which may also be referred to as the rotation rate), corresponding to the estimated angular frequency, to the laser module. For example, the IECC (or in combination with the TMC) may correspond to the controller 200 for controlling laser scanning as described hereinbefore according to various first embodiments. Based on the estimated angular frequency received, the laser module may output a complete omnidirectional scan via the UART to the USB adapter to the IECC. Accordingly, the IECC may perform the angular rate estimation method and the single-point laser module may generate a planar scan from the rotating locomotion of the rotorcraft based on the estimated angular frequency.

### Evaluation of Angular Rate Estimation on FMU Rotating Rig

For illustration purpose and without limitation, FIG. 8 depicts an example experimental setup to simulate the physical rotation of a rotorcraft. In the example experimental setup, the above-mentioned FMU was mounted on a rotating rig which was actuated by a high-torque brushless DC (BLDC) motor. In particular, a FMU rotating rig was custom-designed and developed to physically simulate the rapid rotating motion of a rotorcraft. The rotating rig has mounted thereon the FMU and includes a high-torque T-Motor U10 BLDC motor. The motor shaft is connected to a US Digital E6 Optical Encoder with 10,000 cycles per revolution (CPR) to provide the ground truth angular rate of the rotation. A first Teensy 3.5 microcontroller (MC) interfaces and processes the encoder data and outputs the measured angular frequency via a serial connection to a computer. The computer records and stores the measurements. A second Teensy 3.5 MC commands the rotation speed of the rotating rig by sending a pulse-width modulated (PWM) signal to the electronic speed controller (ESC), which directly controls the power input to the BLDC motor. In this experiment, the PWM commanded was 1170-1310 μs at 10 μs interval.

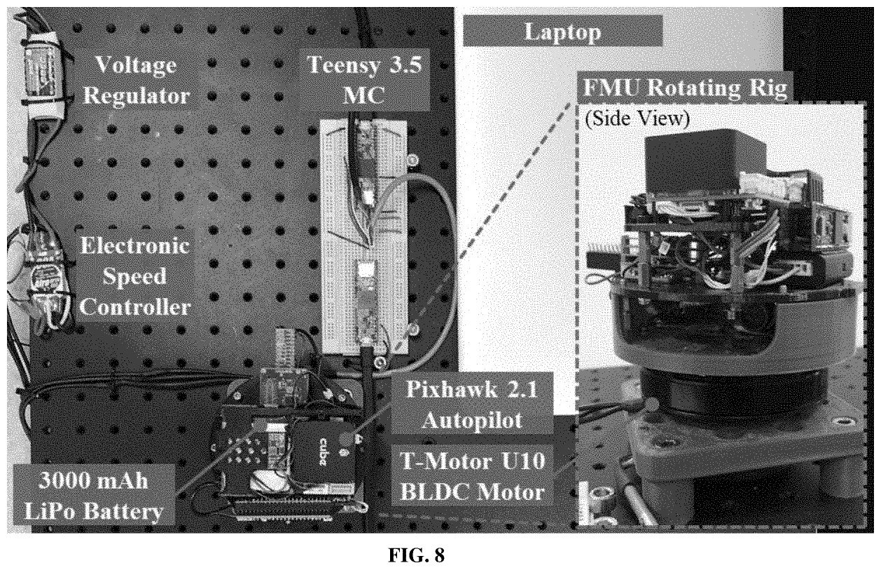

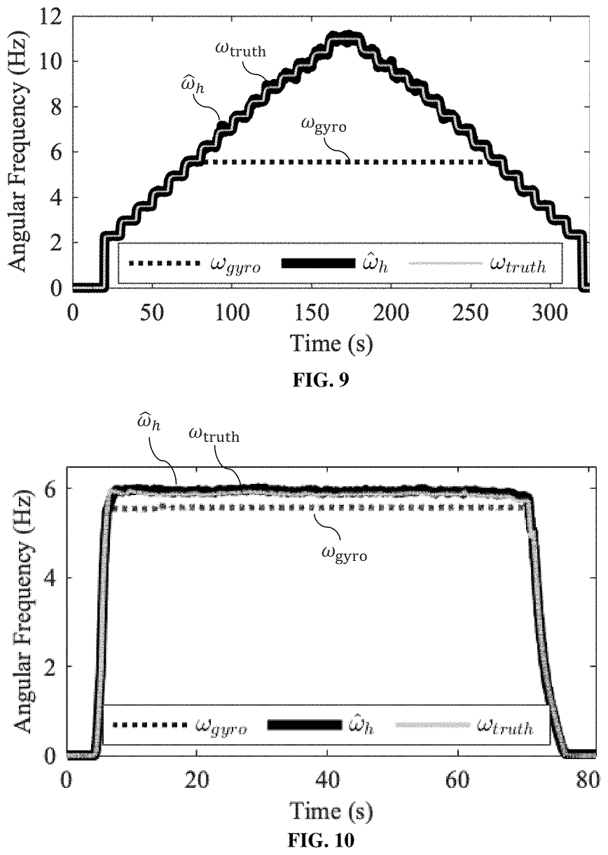

FIG. 9 depicts a graph showing the estimated angular frequency \hat{ω}ₕ according to various first example embodiments of the present disclosure against the ground truth ωₜᵣᵤₜₕ and the gyro measurement ω_{gyro}. It can be observed that the estimated angular frequency \hat{ω}ₕ tracks a staircase function and was able to track the ground truth ωₜᵣᵤₜₕ accurately despite the saturated gyro ω_{gyro}. Significantly, the angular rate estimation method was tested to about twice the gyro saturation limit. In particular, despite ω_{gyro} saturating at 5.5 Hz, the \hat{ω}ₕ tracks the ground truth encoder frequency ωₜᵣᵤₜₕ with a low rms error of 0.0045 Hz.

### Evaluation of EKF Estimation on Flydar Platform

In an experiment conducted, the rotorcraft 400 as shown in FIG. 6 was flown using manual control by a human pilot. The throttle input by the pilot commands the rotorcraft 400 to track a desired angular frequency, ω_{d}. Significantly, ω_{d}≈5.8 Hz is higher than the gyro dynamics range of ω_{gyro,limit}=5.5 Hz and the gyro saturates. The OptiTrack Motion Capture System was used to determine the ground truth angular frequency of the rotation of the rotorcraft 400. The results are shown in FIG. 10. In particular, FIG. 10 depicts a graph showing the angular frequency \hat{ω}ₕ estimated on the rotorcraft 400 during flight according to various first example embodiments of the present disclosure against the ground truth ωₜᵣᵤₜₕ and the gyro measurement ω_{gyro}. It can be observed that the estimated angular frequency \hat{ω}ₕ was able to track the ground truth ωₜᵣᵤₜₕ accurately despite the saturated gyro ω_{gyro}. The rms error at steady state and for the entire flight were 0.056 Hz and 0.051 Hz, respectively.

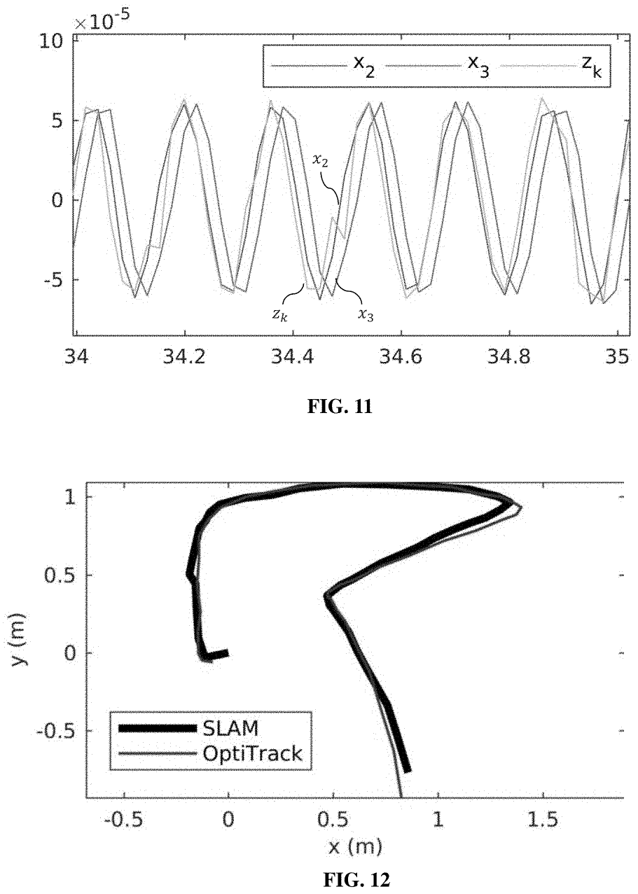

FIG. 11 illustrates the magnetometer measurement zₖ at a one-second window between 34<t<35, verifying the sinusoidal mode of the magnetic field measurement data. In particular, FIG. 11 depicts a one-second snapshot of the magnetometer measurement zₖ and the estimated (or predicted) EKF states x₂ and x₃. As can be seen, the predicted EKF state x₂ tracks the sinusoidal magnetometer sensor data zₖ closely or reasonably, which explains the low rms error of the angular frequency estimate.

### Evaluation of SLAM Performance Using Flydar

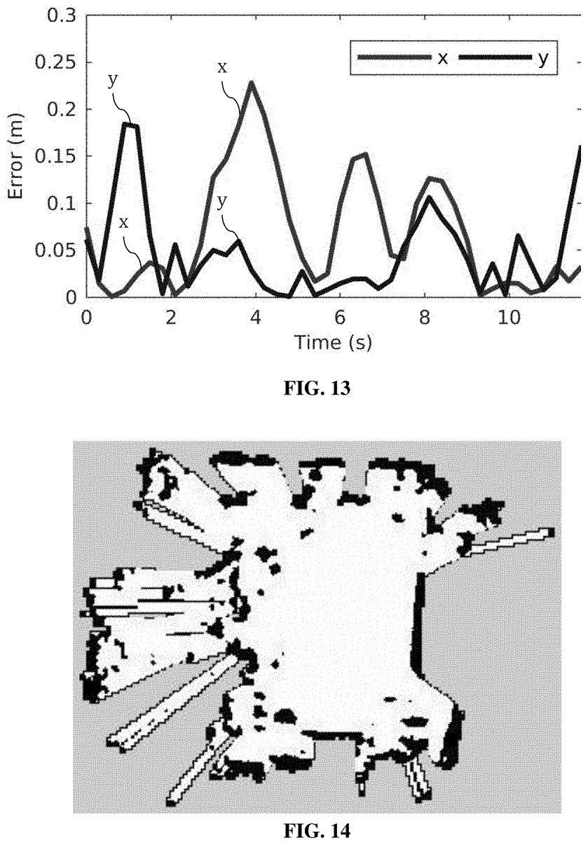

In an experiment conducted, the pilot commands the rotorcraft 400 as shown in FIG. 6 to travel within a bounded area. The ground truth robot pose was recorded using the OptiTrack Motion Capture system. The output of the laser scan was also recorded on the onboard IECC. The rotorcraft 400 pose was recovered using Google Cartographer SLAM in 2D offline with the playback of the recorded laser data. The estimated trajectory from the SLAM and the ground truth trajectory from the OptiTrack are shown in FIG. 12. In particular, FIG. 12 depicts a graph showing the estimated x and y position output from the Google Cartographer SLAM in 2D generated from the rotorcraft 400 planar scan against the ground truth pose of the OptiTrack. The rms euclidean error during the flight was recorded at 0.11 m. The absolute x- and y- error of the position estimate from the SLAM in 2D are shown in FIG. 13. In this regard, the hover flight assumption (i.e., ωₓ=ω_{y}=0) and the processing of the SLAM in 2D (i.e., ϕ=ψ=0) may have contributed to the position error. The final map output generated from the rotorcraft 400 using the Google Cartographer in 2D is shown in FIG. 14.

Accordingly, in various first example embodiments of the present disclosure, a high angular rate estimation for SLAM of a rotorcraft (e.g., Flydar 400) is provided. The EKF-based method (or algorithm) according to various first example embodiments utilizes the sinusoidal magnetometer measurement generated by the continuously rotating airframe for estimation of the robot hovering angular velocity. Advantageously, the EKF-based method according to various first example embodiments does not rely on additional sensors other than existing IMU sensors already being used for flight stabilization. In various first example embodiments, the gyro measurement and the gyro bias are incorporated as a control input and a filter state respectively to enable estimation even under gyro saturation condition. Additionally, various first example embodiments propose leveraging on the inherently rotating locomotion to generate a planar lidar scan using only a single-point laser for possible lightweight autonomy. For example, the angular rate estimation method according to various first example embodiments was experimentally evaluated on a ground rotating rig up to twice the gyro saturation limit with an effective rms error of 0.0045 Hz; and on the rotorcraft 400 hovering beyond the saturation limit with a rms error of 0.0056 Hz. Accordingly, the angular rate estimation method was demonstrated to estimate beyond the gyro saturation limited successfully, such as up to a rms error of 0.00056 Hz. The angular rate was used to output a planar lidar scan from a single-point laser, mounted on the rotating rotorcraft 400. Furthermore, the angular rate estimation method for SLAM using the rotating dynamics of the rotorcraft 400 was demonstrated with a localisation accuracy of 0.11 m.

### Angular Rate Estimation Method Based on Magnetometer Sensor Data and Phase-Locked Loop

According to various second example embodiments (e.g., corresponding to various second embodiments described hereinbefore), there is provided a high angular rate estimation method (or algorithm) based on a numerical phase-locked loop (PLL).

Samara-inspired unmanned aerial vehicle (UAV) is a single or multiple wing rotorcraft inspired by winged samara seeds flight. The entire UAV continuously rotates to generate lift for controlled and sustained flight. Such UAVs may include the monocopter, the Transformable HOvering Rotorcraft (THOR), and the Samara Autorotating Wing (SAW).

The unique all-rotating mode of aerial locomotion underscores key research developments in sensing and estimating the UAV's high angular rates. However, commercially accessible low-cost gyroscope, such as the MPU9250, has poor dynamic range of ±2000 deg/s (≈5.5 Hz) and is too limited for measuring the rotation speed of smaller rotorcraft operating at higher angular rates. Smaller rotorcraft has lesser aerodynamics surface and operates at higher rotation speed to generate sufficient lift. For instance, the robotic samara presented in Ulrich et al., “From falling to flying: the path to powered flight of a robotic samara nano air vehicle,” Bioinspiration & Biomimetics, vol. 5, no. 4, page 045009, November 2010, operates at 15 Hz, which is significantly beyond typical gyroscope limit. Various second example embodiments of the present disclosure provide a PLL-based angular rate estimation method (or algorithm) to estimate the UAV's high angular rates under hardware sensing limitation.

As explained in the background, it has conventionally been challenging to achieve laser scanning (or lidar scanning) by a rotorcraft without significant or material drawbacks, such as significantly or materially increasing weight and/or complexity of the rotorcraft, for example due to additional sensors required, such as accelerometer and barometer. Accordingly, various second example embodiments seek to overcome, or at least ameliorate this problem by providing a PLL-based angular rate estimation method (or algorithm) which relies on measurements available from the existing onboard IMU, without requiring any additional sensors. That is, PLL-based angular rate estimation method is able to estimate the angular rate without any additional sensor data, other than those already made available (already generated) by the onboard IMU during flight, similar to the EKF-based angular rate estimation method according to various first example embodiments of the present disclosure.

PLL is a technique used for synchronisation of an output signal to a reference signal, and may be realised electronically as analog or digital PLL integrated circuits (ICs). Various second example embodiments advantageously leverage on numerical simulation techniques to implement a numerical PLL. In various second example embodiments, the reference signal is the sinusoidal magnetometer waveform generated due to the spinning dynamics of a rotorcraft (e.g., UAV), such as the type of rotorcraft as shown in FIG. 4A. The numerical PLL then estimates the instantaneous frequency of the magnetometer signal, which corresponds to (e.g., equivalent to) the angular frequency of the spinning rotorcraft.

Accordingly, various second example embodiments of the present disclosure provide modelling, analysis and experimental evaluation of the PLL-based angular rate estimation method to estimate the angular rate of a rotorcraft, such as a spinning samara-inspired UAV 400 as shown in FIG. 4A. As explained above, the PLL-based angular rate estimation method does not require additional sensing hardware and uses magnetometer measurements from existing on-board IMU measurement. Accordingly, the PLL-based angular rate estimation method advantageously enables or facilitates miniaturisation of rotorcrafts, especially those that require operation at higher frequency (i.e., higher angular rate, such as higher than the angular rate capable of being measured by a gyroscope mounted on the rotorcraft). An example modelling of a PLL will now be described below according to various second example embodiments. The rotorcraft dynamics and the magnetometer sensor model will then be described. The relationship between the PLL output and the angular rate of the rotorcraft 400 will also be described and analytically established.

### Phase-Locked Loop (PLL) Model

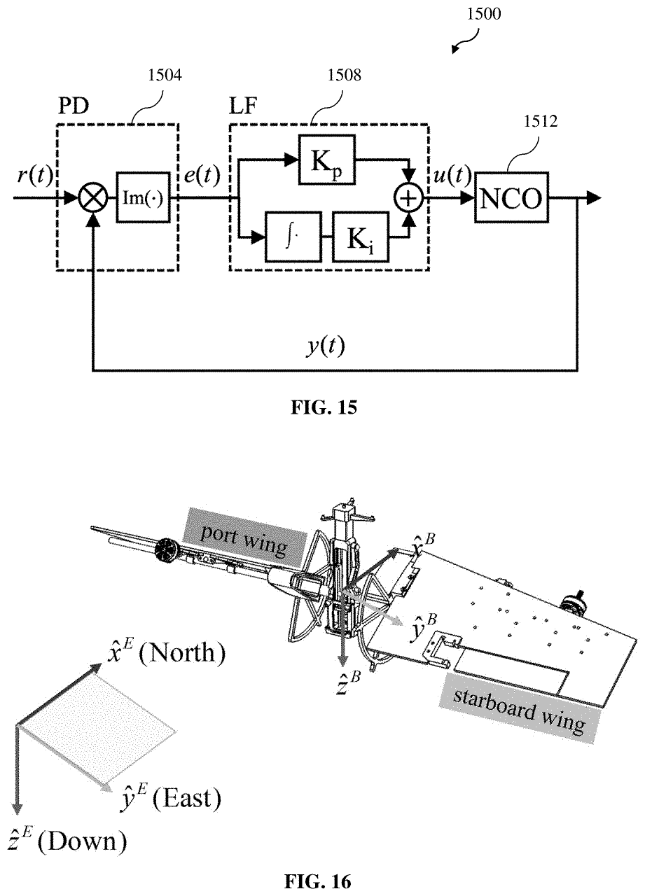

FIG. 15 depicts a schematic block diagram of a PLL 1500, along with a number of key parameters shown, according to various second example embodiments of the present disclosure. The PLL 1500 includes a phase detector (PD) 1504, a loop filter (LF) 1508, and a numerically-controlled oscillator (NCO) 1512.

In various second example embodiments, the reference input signal r(t) and the output signal y(t) of the PLL 1500 are complex sinusoidal signals. In this regard, the signal model of r(t) and y(t) may be expressed as:

r(t)=rₒexp (jωᵢt) Equation (22)

y(t)=yₒexp (jωₒt) Equation (23)

where rₒ and yₒ denote the amplitude of r(t) and y(t), respectively, and ωᵢ and ωₒ denote the angular frequency of r(t) and y(t), respectively.

The PD 1504 may be configured to compare the output signal y(t) to the reference input signal r(t). In various second example embodiments, the PD 1504 may multiply the two signals and output an error signal e(t), which corresponds to the phase difference of y(t) relative to r(t). For example, the output of the PD 1504, e(t), may be expressed as:

$$e ( t ) = {K}_{d} \cdot Im \{ ( r ( t ) \cdot \overline{y} ( t ) ) \} \qquad Equation ( 24 a )$$

$$= {k}_{d} \cdot Im \{ exp ( j ( {ω}_{i} - {ω}_{o} ) t ) \} \qquad Equation ( 24 b )$$

$$= {k}_{d} \cdot sin ( ( {ω}_{i} - {ω}_{o} ) t ) \qquad Equation ( 24 c )$$

where K_{d} is the PD gain, k_{d} is the lumped constant s.t. k_{d}=K_{d}*rₒ*yₒ.

Near steady state, as t→∞, the output signal y(t) becomes synchronous with the reference input signal r(t). Then ωₒ→ωᵢ, and the error (ωᵢ−ωₒ)t→0. Using small angle approximation, Equation (24c) becomes:

$$\begin{matrix}e ( t ) = {k}_{d} \cdot sin ( ( {ω}_{i} - {ω}_{o} ) t ) \\ = {k}_{d} \cdot ( ( {ω}_{i} - {ω}_{o} ) t )\end{matrix} \qquad Equation ( 25 )$$

where e(t) is directly proportional to the phase difference and k_{d} is the proportionality constant.

The LF 1508 may be configured to function as an automatic regulator control system, more specifically, a Proportional-Integral (PI) system. The PD output e(t) is directly connected to the LF. For example, the LF output u(t) may be given as:

u(t)=kₚ·e(t)+kᵢ·∫e(t)dt Equation (26)

where kₚ and kᵢ are the proportional gain and the integral gain, respectively.

In relation to the NCO 1512, the LF output, u(t), directly drives the NCO 1512 which generates a periodic waveform. The NCO output, y(t), is given in Equation (23). The instantaneous angular frequency ωₒ of the NCO 1512 may be expressed as:

ωₒ=ω_{f}+kᵥ·u(t) Equation (27)

where ω_{f} denotes the free-running frequency of the NCO 1512 (i.e., the frequency of the NCO 1512 when the NCO input u(t) is zero), kᵥ denotes the NCO sensitivity gain and u(t) denotes the LF output signal.

At steady state, the ωₒ provides a direct estimate of ωᵢ, which is the unknown angular frequency of r(t). In particular, at steady state, the output signal y(t) is synchronous with the reference signal r(t). Then, ωₒ→ωᵢ, and the LF output signal u(t) in Equation (26) becomes a DC signal. Accordingly, at steady-state, the instantaneous frequency of the NCO 1512 is the frequency of the tracked/reference signal.

With sufficient details of the PLL 1500 described herein, a condition (or requirement) of the PLL input r(t) and output signal y(t) according to various second example embodiments of the present disclosure will now be discussed. As explained above, in the PPL model formulation, the PLL input r(t) and output signal y(t) given in Equations (22) and (23), respectively, are assumed to be a complex sinusoid. If r(t) and y(t) are real-valued signal, the multiplier in the PD 1504 will result in an additional higher harmonic signal which needs to be filtered. Instead, the output of the PD 1504, e(t), becomes:

$$e ( t ) = {K}_{d} \cdot Re \{ r ( t ) \} \cdot Re \{ y ( t ) \} \qquad Equation ( 28 a )$$

$$= {K}_{d} \cdot cos ( {ω}_{i} t ) \cdot cos \{ {ω}_{o} t \} \qquad Equation ( 28 b )$$

$$= {k}_{d} \cdot \{ cos ( ( {ω}_{i} - {ω}_{o} ) t ) + cos ( ( {ω}_{i} + {ω}_{o} ) t ) \} \qquad Equation ( 28 c )$$

$$= {k}_{d} \cdot \{ {u}_{-} + {u}_{+} \} \qquad Equation ( 28 d )$$

where e(t) becomes a sum of a low frequency u₋=cos ((ωᵢ−ωₒ)t) and a high frequency u₊=cos ((ωᵢ+ωₒ)t) component.

As a result, the subsequent LF block has to be complicated with an additional low-pass filter, which introduces estimation delay, to suppress the higher frequency component u₊ in Equation (28d). After which, the low frequency component u₋, which corresponds to the phase difference, can then be used in the LF designed in Equation (26).

Hence, the above-mentioned condition that the PLL input signal r(t) with unknown angular frequency ωᵢ is a complex sinusoidal signal leads to a simpler PLL model. It advantageously eliminates the need to implement a low-pass filter which introduces estimation lag and increases complexity.

FIG. 16 shows the axes of the earth-fixed frame E and the body-fixed frame B, according to various embodiments of the present disclosure.

In various second example embodiments of the present disclosure, the rotorcraft and sensor modelling may be the same or similar as described hereinbefore according to various first example embodiments, such as in relation to Equations (1) to (9). In various second example embodiments, the normalized magnetometer measurement \hat{m}^{B} may be expressed as:

$${\hat{m}}^{B} = [ \begin{matrix}{m}_{x} \\ {m}_{y} \\ {m}_{z}\end{matrix} ] = [ \begin{matrix}{m}_{N} cos ( {ω}_{h} t + {ϕ}_{x} ) \\ {m}_{N} sin ( {ω}_{h} t + {ϕ}_{y} ) \\ {m}_{D}\end{matrix} ] + {ϵ}_{m} \qquad Equation ( 29 )$$

where the mₓ and m_{y} measures a sinusoid with angular frequency ωₕ corresponding to rotorcraft's rotating speed, ϕₓ and ϕ_{y} are initial phase shifts, and ϵₘ describes the measurement noise.

Accordingly, a gyroscope mounted on the rotorcraft's body frame B measures the rotorcraft's angular velocity ω^{B}, however, subjected to the dynamic range of the gyroscope. At steady state flight condition as described in Equation (5), the gyroscope output can be modelled as:

$${ω}_{gyro}^{B} = [ \begin{matrix}0 \\ 0 \\ {ω}_{gyro , z}\end{matrix} ] = [ \begin{matrix}0 \\ 0 \\ min \{ {ω}_{h} , {ω}_{gyro}^{limit}\end{matrix} ] + {ϵ}_{gyro} \qquad Equation ( 30 )$$

where ωₕ rotorcraft's true hovering angular velocity as defined in Equation (5), ω_{gyro}^{limit} denotes the gyroscope saturation limit and gyro describes the measurement noise. For instance, if ωₕ>ω_{gyro}^{limit}, the gyroscope output is simply the saturation limit ω_{gyro}^{limit}.

Based on the rotorcraft and sensor modelling, how to construct a complex sinusoidal signal from real-world sensor that outputs only real-valued data will now be described according to various second example embodiments of the present disclosure

### PLL and Rotorcraft Dynamics

A key underlying condition of the PLL model 1500 formulated according to various second example embodiments of the present disclosure is that the input signal r(t) is a complex sinusoid. Significantly, while the magnetometer sensor data are real-valued, it is observed that mₓ and m_{y} component of the magnetometer measurement in Equation (29) are in phase quadrature, that is, the signals are

$$\frac{π}{2}$$

out of phase. The quadrature characteristic of the magnetometer measurement model derived in Equation (29) is conveniently leveraged to construct the complex sinusoidal input signal r(t) from real-valued magnetometer measurements \hat{m}^{B}. Then, the PLL input r(t) can be given as:

r(t)=mₓ+jm_{y} Equation (31)

where mₓ and m_{y} are the x and y component of the magnetometer output \hat{m}^{B}.

Also, the instantaneous angular frequency estimated by the PLL ω_{PLL} is that of the NCO ωₒ:

ω_{PLL}=ωₒ=ωₕ Equation (32)

Lastly, the frequency estimate ω_{PLL} is useful when the gyroscope measurement is measured, that is, ωₕ≥ω_{gyro}^{limit}. However, it is still desirable to use the gyroscope output directly when ωₕ<ω_{gyro}^{limit}. This can be conventionally achieved by setting the free-running frequency ω_{f} of the NCO 1512 to be time-varying. Specially, the value of ω_{f} is determined by the gyroscope output, that is:

ω_{f}=ω_{gyro,z} Equation (33)

where ω_{gyro,z} is the z-axis component of the gyroscope output ω_{gyro}^{B}. Then, according to Equation (25), the PD output e(t)=0. Hence, when ωₕ≤ω_{gyro}^{limit}, the PLL output is simply the gyroscope output ω_{PLL}=ωₒ=ω_{f}=ω_{gyro}.

### Numerical Simulation

A simulation study was conducted to evaluate the performance of the PLL-based angular rate estimation according to various second example embodiments. To simulate the magnetometer output from a rotating UAV, a noise-free sinusoidal with angular frequency ωᵢ=ωₕ, where ωₕ is the angular frequency of the rotating rotorcraft. This is used as the reference input r(t) to the PLL. The free-running frequency of the NCO is set at ω_{f}=ω_{gyro,z}, and the gyroscope output is simulated to saturate at ω_{gyro}^{limit}=5.5 Hz.

### Steady-State and Transient Response of the PLL

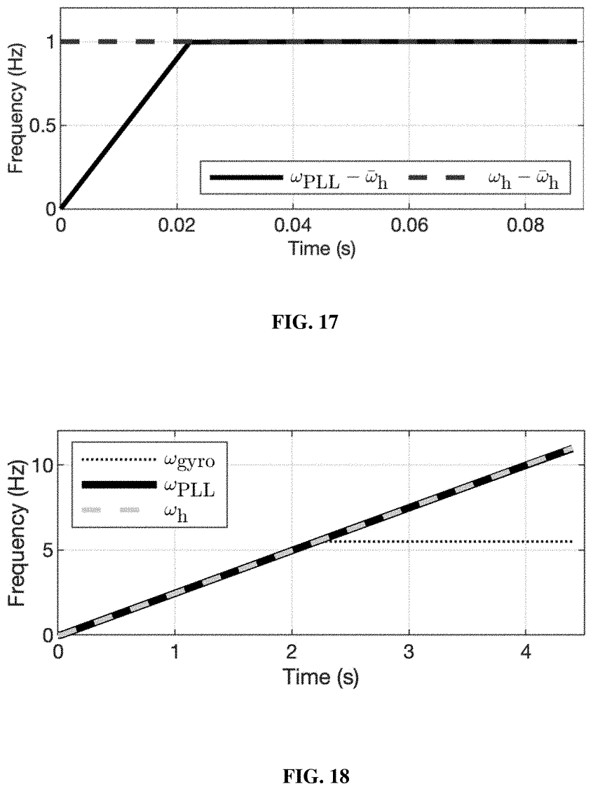

A first numerical simulation analyses the steady-state response of the PLL estimation according to various second example embodiments, when operating above ω_{gyro}^{limit}. The rotorcraft was initially assumed to be at hovering equilibrium exactly on ω_{gyro}^{limit}, such that ω̅ₕ=ω_{gyro}^{limit}. Then, at t=0, a unit step increase in frequency above ω̅ₕ is simulated. The step response of the PLL to a unit step input is shown in FIG. 17. In particular, FIG. 17 depicts a graph of the response of the PLL frequency estimate ω_{PLL} to a unit step frequency increase above ω̅ₕ. The settling time is 0.0218 seconds with zero steady-state error.

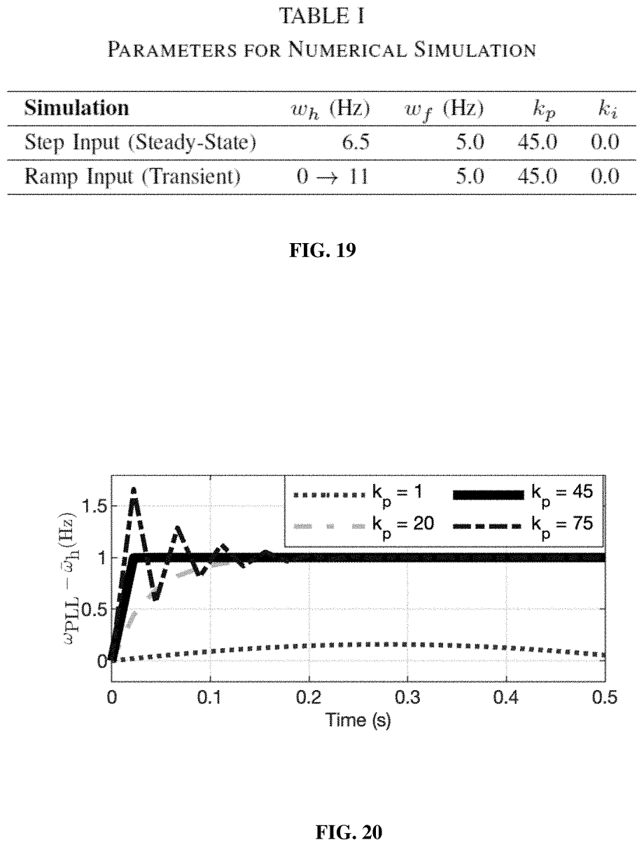

A second numerical simulation evaluates the transient tracking performance of the estimation. A reference input frequency ωᵢ was increase from 0 to 11 Hz, which is twice the ω_{gyro}^{limit}. The ramp slope was set at 2.5 Hz/sec, based on the operating climb rate of the actual rotorcraft described later below with reference to FIG. 20 according to various second example embodiments of the present disclosure. The ramp response of the PLL is shown in FIG. 18. In particular, FIG. 18 depicts a graph of the response of the PLL frequency estimate ω_{PLL} to a unit step frequency increase above ω̅ₕ. It can be observed that the estimator tracks the reference frequency accurately with zero steady-state error. The parameters used for the simulations are shown in Table 1 in FIG. 19.

### Effects of PLL Parameters on Frequency Tracking

The PLL parameters are varied to investigate the effects of its convergence behavior. Since the simulations presented earlier shows that there are no steady-state error, the effects of kᵢ is omitted. Instead, only the effects of kₚ are studied. Similar to the step-response numerical study earlier, a unit step increase in frequency above ωₕ is simulated. The PLL output response ω_{PLL}−ωₕ at four different values of kₚ=1, 20, 45 and 75 are shown in FIG. 20. In particular, FIG. 20 depicts a graph showing the convergence behavior of the PLL at 4 different proportional gains kₚ=1, 20, 45 and 75. At kᵥ=1.0, the PLL frequency estimate ω_{PLL} converged the fastest to a unit ω_{PLL}−ω̅ₕ signal.

It can be observed that at kₚ=45, the PLL frequency estimate converged to the reference frequency the fastest. At a high kₚ of kₚ=75, the output is under-damped with oscillatory overshoot behaviour. At a low kₚ of kₚ=20, the response is over-damped and takes a significantly longer time to settle when compared to when kₚ=45. Finally, when the gain kₚ=1 is too low, the response oscillate about zero and does not converge to the final value.

### Experimental Results

The various experimental investigations conducted to evaluate the performance of the PLL-based frequency estimator according to various second example embodiments of the present disclosure will now be described.

### Hardware: Mini Transformable Hovering Rotorcraft (Mini-THOR)

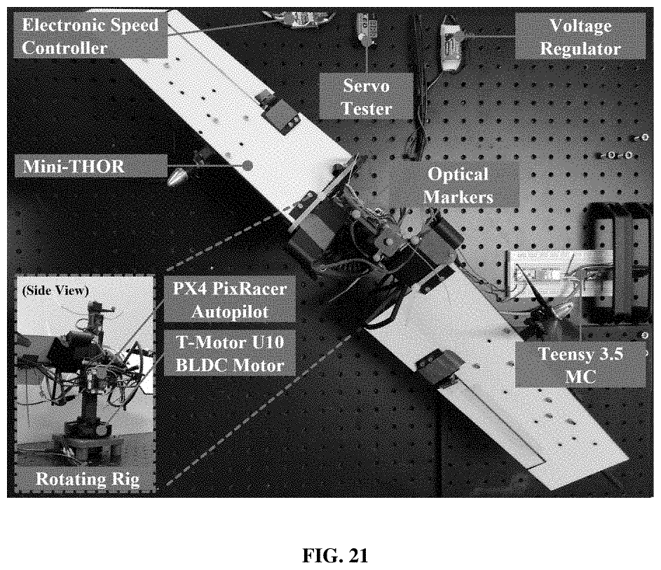

The platform used for experimental evaluation of the PLL-based frequency estimator is the Mini Transformable Hovering Rotorcraft (Mini-THOR), as shown in FIG. 21. In particular, FIG. 21 depicts an example experimental setup to simulate the physical rotation of the robot. The mini-THOR is mounted on the rotating rig being actuated by a high-torque BLDC motor. The mini-THOR uses the DJI Snail 2305 powertrain, a Pixracer R15 autopilot with built-in IMU. Optical markers are mounted on the rotorcraft to provide ground truth measurements of the rotorcraft's angular states. The rotorcraft weighs 300 g and have a wingspan of about 0.7 m.

### Evaluation of Angular Rate Estimation on Bench-top Rotating Rig

A rotating rig was custom-designed and developed to physically simulate the rapid rotating motion of the rotorcraft. The rotating rig has mounted thereon the Mini-THOR on a high-torque T-Motor U10 BLDC motor. The motor shaft connects to a US Digital E6 Optical Encoder with 10,000 cycles per revolution (CPR) to provide the ground truth angular rate of the rotation. A first Teensy 3.5 microcontroller (MC) interfaces and processes the encoder data and outputs the measured angular frequency via a serial connection to a computer. The computer records and stores the measurements. A second Teensy 3.5 MC commands the rotation speed of the rotating rig by sending a pulse-width modulated (PWM) signal to the electronic speed controller (ESC), which directly controls the power input to the BLDC motor.

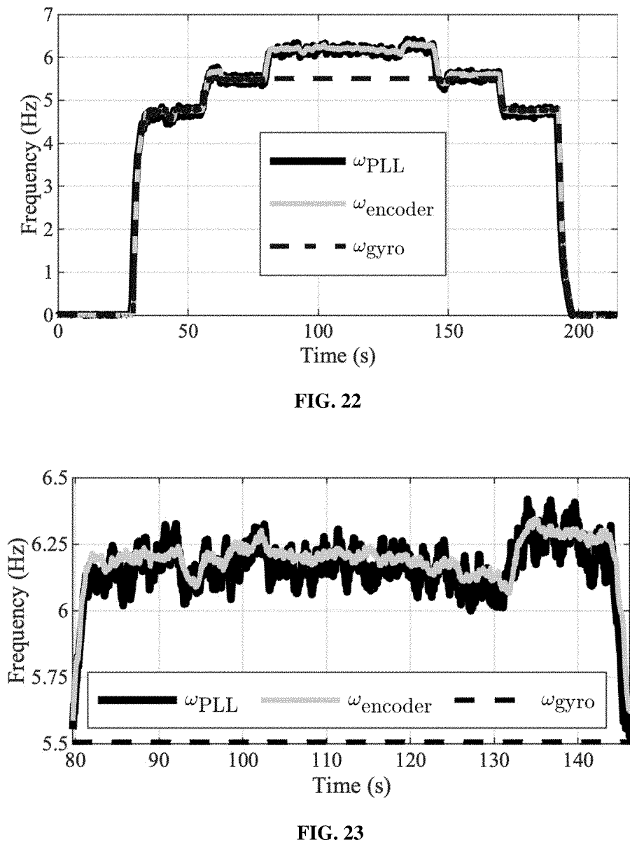

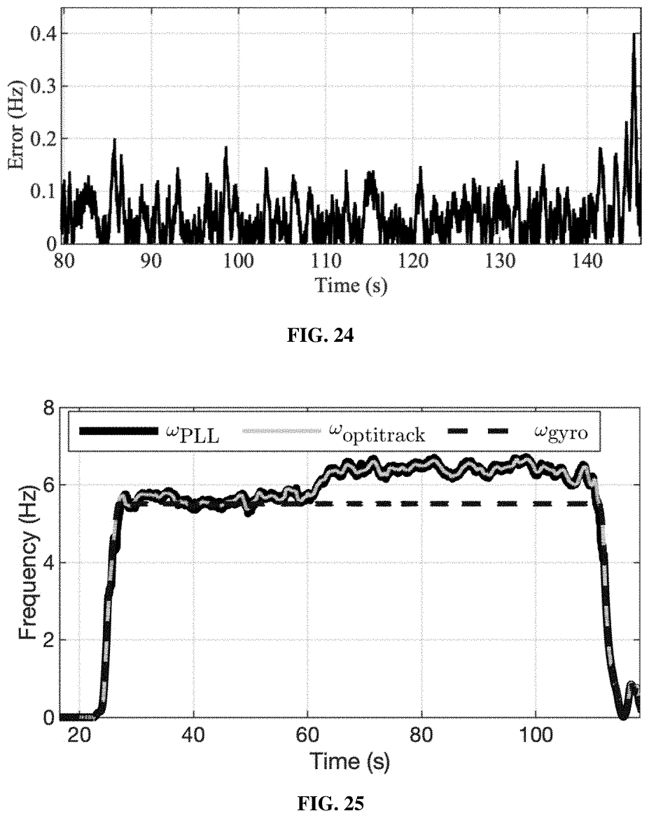

In FIG. 22, the instantaneous frequency ω_{PLL} from the PLL is compared against the ground truth measurement from the OptiTrack Motion Capture System and the gyro measurement. In particular, FIG. 22 depicts a graph showing the PLL instantaneous frequency ω_{PLL} estimated from the PLL compared against the ground truth measurement from the encoder ω_{encoder} and the on-board gyroscope ω_{gyro}. It can be observed that the estimated angular frequency ω_{PLL} was able to track the ground truth ω_{encoder} accurately despite the saturated gyro ω_{gyro}. The rms error was 0.0674 Hz and max error was 0.4 Hz. FIG. 23 depicts a graph showing the frequency output from PLL ω_{PLL}, the encoder ω_{encoder} and the on-board gyroscope ω_{gyro}, when the rotating rig was spun above the ω_{gyro}^{limit}. The absolute error is shown in FIG. 24. In particular, FIG. 24 depicts a graph showing the absolute error of the PLL frequency estimate |ω_{PLL}−ω_{encoder}|.

### Evaluation of Angular Rate Estimation In-Flight

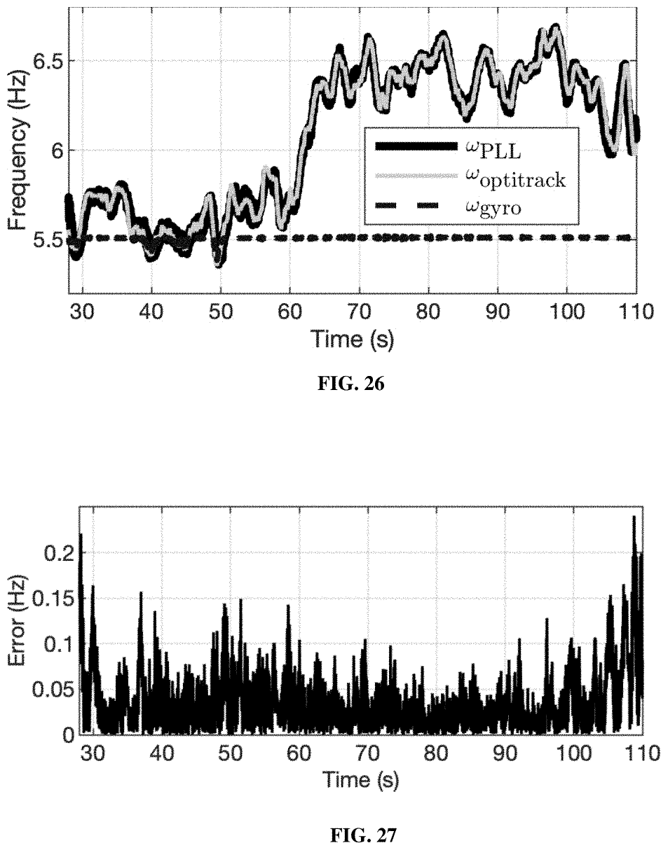

In an experiment conducted, the rotorcraft was flown using manual control by a human pilot. The throttle input by the pilot commands the robot to track a desired angular frequency, ω_{d}. Significantly, ω_{d}≈6.5 Hz is higher than the gyro dynamics range of ω_{gyro,limit}=5.5 Hz and the gyro saturates. Optical markers are placed on the rotorcraft and the OptiTrack Motion Capture System was used to determine the ground truth angular frequency of the rotorcraft rotation. The results are shown in FIG. 25. In particular, FIG. 25 depicts a graph showing the PLL frequency estimate ω_{PLL} compared against the ground truth measurement from the OptiTrack ω_{optitrack} and the on-board gyroscope ω_{gyro}. It can be observed that the estimated angular frequency ω_{PLL} was able to track the ground truth ω_{optitrack} accurately despite the saturated gyro ω_{gyro}. The rms error and max error at steady state was 0.0479 Hz and 0.2406 Hz, respectively. FIG. 26 illustrates the absolute frequency error during steady-state 28<t<110, when the rotorcraft is operating above the gyro saturation condition. In particular, FIG. 26 depicts a graph showing the PLL frequency estimate ω_{PLL} is compared against the ground truth measurement from the OptiTrack ω_{optitrack} and the on-board gyroscope ω_{gyro}, when the Mini-THOR is hovering at an angular frequency above ω_{gyro}^{limit}. FIG. 27 depicts a graph showing the absolute error of the PLL frequency estimate |ω_{PLL}−ω_{optitrack}|, whereby the maximum error is 0.2406 Hz and the rms error is 0.0479 Hz.

According, a PLL-based angular rate estimation method is provided according to various second example embodiments of the present disclosure. The PLL-based angular rate estimation method is advantageously able to estimate the high angular rate of a rotating rotorcraft even when typical hardware gyroscopic sensor saturates. The estimator was evaluated in numerical simulation with a low rms error of 0.067 Hz with zero steady-state error. It was also experimentally evaluated on a flying platform with low rms error of 0.048 Hz. For example, a numerical PLL algorithm for estimation of the high angular rate of samara-inspired rotorcraft is provided according to various second example embodiments of the present disclosure. The sinusoidal magnetometer measurements generated from the spinning rotorcraft is provided as the reference input to the PLL. The PLL then estimates the instantaneous frequency of the input and outputs a synchronous waveform. Significantly, the PLL-based angular rate estimation method enables estimation of the rotorcraft's angular velocity even when it operates beyond gyro saturation condition. The PLL-based angular rate estimation method was numerically evaluated and the effects of the PLL gains parameters are demonstrated in simulation. The PLL was shown to have a fast settling time, at about 0.02 seconds, to a step change in the input reference with a well-selected gain. The PLL was demonstrated to accurately track a ramp input change of up to 11 Hz, which is twice the gyroscope saturation limit, with zero steady-state error. Furthermore, the PLL-based angular rate estimation method was experimentally evaluated on a benchtop setup, for up to 6.3 Hz, with an rms error of 0.04006 Hz; and in actual UAV flight, up to 6.5 Hz, with a rms error of 0.0479 Hz.

In various example embodiments, the rotorcraft configured to perform laser scanning according to various first example embodiments and the rotorcraft configured to perform laser scanning according to various second example embodiments may be configured in the same or similar manner except that the former has a controller for controlling laser scanning configured according to various first example embodiments as described hereinbefore (i.e., based on EKF-based angular rate estimation) and the latter has a controller for controlling laser scanning configured according to various second example embodiments as described hereinbefore (i.e., based on PLL-based angular rate estimation).

While embodiments of the disclosure have been particularly shown and described with reference to specific embodiments, it should be understood by those skilled in the art that various changes in form and detail may be made therein without departing from the scope of the disclosure as defined by the appended claims. The scope of the disclosure is thus indicated by the appended claims and all changes which come within the meaning and range of equivalency of the claims are therefore intended to be embraced.

1. A method of controlling laser scanning by a rotorcraft, the rotorcraft comprising a rotatable body frame configured to rotate during flight; a laser rangefinder mounted on the rotatable body frame and configured to perform laser scanning; and a magnetometer configured to measure magnetic field, the method comprising:
obtaining magnetic field measurement data from the magnetometer while the rotatable body frame is rotating during flight, the magnetic field measurement data comprising a sinusoidal signal;
estimating a frequency of the sinusoidal signal; and
controlling the laser rangefinder to perform laser scanning based on the estimated frequency of the sinusoidal signal.

2. The method according to claim 1, wherein the frequency of the sinusoidal signal is estimated based on an extended Kalman filter.

3. The method according to claim 2, wherein
the rotorcraft further comprises a gyroscope mounted on the rotatable body frame and configured to measure an angular velocity thereof about a rotational axis of the rotatable body frame, and
said estimating the frequency of the sinusoidal signal comprises:
obtaining gyroscope measurement data from the gyroscope, the gyroscope measurement data comprising measured angular velocity data measured by the gyroscope about the rotational axis of the rotatable body frame; and
computing the frequency of the sinusoidal signal based on the measured angular velocity data as a control input to the extended Kalman filter.

4. The method according to claim 3, wherein
said estimating the frequency of the sinusoidal signal further comprises estimating a gyro bias associated with the gyroscope in relation to the measured angular velocity data based on an estimated state in the extended Kalman filter, and
said computing the frequency of the sinusoidal signal is further based on the estimated gyro bias,
wherein
the extended Kalman filter is based on a state transition function,
the measured angular velocity data is a control input to the state transition function, and
the estimated gyro bias is an estimated state in the state transition function.

5. (canceled)

6. The method according to claim 4, wherein said computing the frequency of the sinusoidal signal is further based on a difference between the measured angular velocity data and the estimated gyro bias.

7. The method according to claim 1, wherein the frequency of the sinusoidal signal is estimated based on a phase-locked loop, wherein
the phase-locked loop comprises a phase detector, a loop filter and a numerically-controlled oscillator, the phase detector being configured to compare a phase of an output signal of the phase-locked loop with a phase of a reference input signal of the phase-locked loop to produce an error signal, and
the reference input signal is based on the sinusoidal signal of the magnetic field measurement data.

8. (canceled)

9. The method according to claim 7, wherein each of the reference input signal and the output reference signal is a complex sinusoidal signal.

10. The method according to claim 9, wherein the complex sinusoidal signal of the reference input signal is produced based on a first component and a second component of the sinusoidal signal, the first component corresponding to a front direction of the rotorcraft and the second component corresponding to a starboard direction of the rotorcraft.

11. The method according to claim 7, wherein the frequency of the sinusoidal signal is estimated based on an instantaneous frequency of the numerically-controlled oscillator.

12. The method according to claim 11, wherein
the rotorcraft further comprises a gyroscope mounted on the rotatable body frame and configured to measure an angular velocity thereof about a rotational axis of the rotatable body frame, and
said estimating the frequency of the sinusoidal signal comprises:
obtaining gyroscope measurement data from the gyroscope, the gyroscope measurement data comprising measured angular velocity data measured by the gyroscope about the rotational axis of the rotatable body frame; and
setting a free-running frequency of the numerically-controlled oscillator based on the measured angular velocity data.

13. The method according to claim 1, wherein said controlling the laser rangefinder comprises:
determining an angular velocity of the rotorcraft based on the estimated frequency of the sinusoidal signal; and
sending the determined angular velocity of the rotorcraft to the laser rangefinder, the laser rangefinder being configured to perform laser scanning based on the determined angular velocity of the rotorcraft.

14. The method according to claim 13, wherein
the laser rangefinder is a single unidirectional laser and is configured to generate planar pointcloud data for a complete planar lidar scan based on the determined angular velocity of the rotorcraft, and
the complete planar lidar scan is a planar lidar scan having completed a full revolution as determined based on the determined angular velocity of the rotorcraft.

15. (canceled)

16. A controller for controlling laser scanning by a rotorcraft, the rotorcraft comprising a rotatable body frame configured to rotate during flight; a laser rangefinder mounted on the rotatable body frame and configured to perform laser scanning; and a magnetometer configured to measure magnetic field, the controller comprising:
a memory; and
at least one processor communicatively coupled to the memory and configured to:
obtain magnetic field measurement data from the magnetometer while the rotatable body frame is rotating during flight, the magnetic field measurement data comprising a sinusoidal signal;
estimate a frequency of the sinusoidal signal; and
control the laser rangefinder to perform laser scanning based on the estimated frequency of the sinusoidal signal.

17. The controller according to claim 16, wherein the frequency of the sinusoidal signal is estimated based on an extended Kalman filter.

18. The controller according to claim 17, wherein
the rotorcraft further comprises a gyroscope mounted on the rotatable body frame and configured to measure an angular velocity thereof about a rotational axis of the rotatable body frame, and
said estimate the frequency of the sinusoidal signal comprises:
obtaining gyroscope measurement data from the gyroscope, the gyroscope measurement data comprising measured angular velocity data measured by the gyroscope about the rotational axis of the rotatable body frame; and
computing the frequency of the sinusoidal signal based on the measured angular velocity data as a control input to the extended Kalman filter.

19. (canceled)

20. (canceled)

21. (canceled)

22. The controller according to claim 16, wherein the frequency of the sinusoidal signal is estimated based on a phase-locked loop, wherein
the phase-locked loop comprises a phase detector, a loop filter and a numerically-controlled oscillator, the phase detector being configured to compare a phase of an output signal of the phase-locked loop with a phase of a reference input signal of the phase-locked loop to produce an error signal, and
the reference input signal is based on the sinusoidal signal of the magnetic field measurement data.

23. (canceled)

24. (canceled)

25. (canceled)

26. The controller according to claim 22, wherein the frequency of the sinusoidal signal is estimated based on an instantaneous frequency of the numerically-controlled oscillator.

27. The controller according to claim 26, wherein
the rotorcraft further comprises a gyroscope mounted on the rotatable body frame and configured to measure an angular velocity thereof about a rotational axis of the rotatable body frame, and
said estimate the frequency of the sinusoidal signal comprises:
obtaining gyroscope measurement data from the gyroscope, the gyroscope measurement data comprising measured angular velocity data measured by the gyroscope about the rotational axis of the rotatable body frame; and
setting a free-running frequency of the numerically-controlled oscillator based on the measured angular velocity data.

28. (canceled)

29. (canceled)

30. The controller according to claim 16, wherein the rotorcraft is configured to entirely rotate during flight.

31. A rotorcraft configured to perform laser scanning, the rotorcraft comprising:
a rotatable body frame configured to rotate during flight;
a laser rangefinder mounted on the rotatable body frame and configured to perform laser scanning;
a magnetometer configured to measure magnetic field; and
the controller for controlling the laser rangefinder to perform laser scanning,
the controller comprising:
a memory; and
at least one processor communicatively coupled to the memory and configured to:
obtain magnetic field measurement data from the magnetometer while the rotatable body frame is rotating during flight, the magnetic field measurement data comprising a sinusoidal signal;
estimate a frequency of the sinusoidal signal; and
control the laser rangefinder to perform laser scanning based on the estimated frequency of the sinusoidal signal.

32. (canceled)
